(19) United States
(12) Patent Application Publication
(10) Pub. No.: US 2023/0292125 A1
(43) Pub. Date: Sep. 14, 2023

(54) SECURITY ESTABLISHMENT FOR NON-PUBLIC NETWORKS

(71) Applicant: Telefonaktiebolaget LM Ericsson (publ), Stockholm (SE)

(72) Inventors: Noamen BEN HENDA, Vällingby (SE); Vesa LEHTOVIRTA, Espoo (FI); Henrik NORMANN, Malmö (SE); David CASTELLANOS ZAMORA, Madrid (ES)

(21) Appl. No.: 18/018,957

(22) PCT Filed: Aug. 10, 2021
(86) PCT No.: PCT/EP2021/072243

§ 371 Date: Jan. 31, 2023

Related U.S. Application Data
(60) Provisional application No. 63/066,464, filed on Aug. 17, 2020.

(51) Int. Cl. H04W 12/069; H04W 12/0431

(52) U.S. Cl. CPC H04W 12/069; H04W 12/0431

(57) ABSTRACT

A method by a first core network (CN) node of a core network of a wireless communication system for authenticating a user equipment (UE) to the CN. The method includes receiving, from a second CN node, a first authentication request to authenticate the UE to the CN, and determining that the UE should be authenticated by an external authentication entity that is external to the wireless communication system. The first CN node transmits a second authentication request toward the external authentication entity, and receives a first authentication response verifying authenticity of the UE. The method further includes obtaining a key for securing communications with the UE based on the authentication response, and transmitting a second authentication response to the second CN node identifying the UE and including the key for securing communications with the UE.

### FIELD

The present disclosure relates generally to communications, and more particularly, to wireless communications and related wireless devices and network nodes.

### BACKGROUND

A simplified wireless communication system is illustrated in FIG. 1. The system includes a UE 100 that communicates with one or more access nodes 110, 120 using radio connections 107, 108. The access nodes 110, 120 are connected to a core network node 200. The access nodes 110, 120 are part of a radio access network 105.

For wireless communication systems pursuant to 3GPP 5G System, 5GS (also referred to as New Radio, NR, or 5G) standard specifications, such as specified in 3GPP TS 38.300 and related specifications, the access nodes 110, 120 correspond typically to a 5G NodeB (gNB) and the network node 200 corresponds typically to either an Access and Mobility Management Function (AMF) and/or a User Plane Function (UPF). The gNB is part of the radio access network 105, which in this case is the NG-RAN (Next Generation Radio Access Network), while the AMF and UPF are both part of the 5G Core Network (5GC).

The 5G System consists of the access network and the core network. The Access Network (AN) is the network that allows the UE 100 to gain connectivity to the Core Network (CN), e.g. the base station which could be a gNB or an ng-eNB in 5G. The CN contains all the Network Functions (NF) ensuring a wide range of different functionalities such as session management, connection management, charging, authentication, etc. FIG. 2, which is reproduced from TS 23.501 [3] gives a high overview of the 5G architecture for the non-roaming scenario.

The communication links between the UE and the network (AN and CN) are partitioned into two strata. The UE communicates with the CN over the Non-Access Stratum (NAS), and with the AN over the Access Stratum (AS). All the NAS communication takes place between the UE and the Access and connectivity Management Function (AMF) in the CN over the NAS protocol (N1 interface in FIG. 2). Protection of the communications over these strata is provided by the NAS protocol (for NAS) and the PDCP protocol (for AS).

One important NAS procedure is the Primary Authentication which is typically performed upon initial registration of the UE. In addition to the UE, this procedure involves the AMF in the visited PLMN (VPLMN), in case the UE is roaming, and the Authentication Server Function (AUSF)/Unified Data Management (UDM)/Authentication credential Repository and Processing Function (ARPF) in the Home PLMN (HPLMN). The Security Anchor Function (SEAF) is co-located with the AMF. In the remainder of the description, the terms SEAF and AMF are used interchangeably.

Following the initiation step, the authentication method is selected by the Unified Data Management (UDM) function and then performed by the Authentication Server Function (AUSF) and the UE. TS 33.501 [4] mandates the support of two authentication methods. The 5G Authentication and Key Agreement (AKA) is an enhanced version of the EPS AKA described in TS 33.401 [5] for the previous generation of mobile networks, i.e. LTE. The other method, called EAP-AKA′, is based on the Extensible Authentication Protocol (EAP). EAP is a well-established IETF protocol which is flexible and provides an authentication framework allowing the use of different authentication methods called EAP-methods depending on the type of credentials. EAP-AKA′ is one of those EAP methods and is specified in RFC 5448 [7].

For AKA-based methods like 5G AKA and EAP-AKA′, it is assumed that the UE is preconfigured with AKA credentials typically stored in the Universal Subscriber Identity Module (USIM). Such credentials include the long-term key K and the Subscription Permanent Identifier (SUPI).

In general, the security mechanisms for NAS and AS communications rely on multiple different security keys. In the 5G security specification, these keys are organized in a hierarchy, shown in FIG. 3. At the top level is the long-term key K that is part of the authentical credential and that is stored in the USIM of the UE and in the UDM/ARPF on the network side. A successful run of the Primary Authentication procedure leads to the establishment of security key K_{AUSF} between the AUSF and the UE and the derivative key K_{SEAF} between the SEAF and the UE. The K_{SEAF} key is used to derive further keys to secure NAS and AS communication.

These lower level keys together with other security parameters such as the cryptographic algorithms, the UE security capabilities, the value of the counters used for replay protection in the different protocols, etc., constitute what is defined as the 5G security context in TS 33.501 [4]. It should be noted that the K_{AUSF} key is not part of the 5G security context since 5G security context resides in the serving network.

The K_{AUSF} key is also used for other features introduced in the 5G System to secure the exchange of information between the Home PLMN and the UE, such as for the provisioning of parameters to the UE from the UDM in the Home PLMN. More precisely the K_{AUSF} key is used for the integrity protection of the messages delivered from the Home PLMN to the UE. As described in TS 33.501 [4], such new features include the Steering of Roaming (SoR) and the UDM parameter delivery procedures.

Release 16, which 3GPP finalized recently, delivers several new features in the 5G System. One of these features is the support for the so-called Non-Public Network (NPN) as described in TS 23.501 [3]. This feature is intended to help verticals make use of the 5G System services by either deploying their own standalone 5G System, a concept denoted by standalone Non-Public Network (SNPN) or via a PLMN, called Public Network integrated NPN (PNi-NPN). An example of an SNPN is a private 5G System deployed in a factory or business campus to provide connectivity both to machines and workers.

Among the enhancements specified for SNPNs are updates to the primary authentication procedure in order to support any key-generating EAP methods. For example, the key hierarchy has been updated to exclude keys outside the EAP-protocol realm as illustrated in FIG. 3. These are keys tied to the authentication credentials and specific to the EAP method. As shown in FIG. 3, an EAP authentication method generates an extended master session key (EMSK) based on EAP method credentials. The K_{AUSF} key is derived from the EMSK.

3GPP is currently working on Release 17 enhancement to the NPN support. The architectural study work is captured in TR 23.700-07 [1]. Among the objectives of this work is to further enhance the authentication procedures in order to allow UEs to be authenticated by an external entity to the SNPN.

### SUMMARY

Some embodiments provide a method performed by a first core network node of a core network of a wireless communication system for authenticating a user equipment, UE, to the core network. The method includes receiving, from a second core network node, a first authentication request to authenticate the UE to the core network, the first authentication request identifying the UE, and determining that the UE should be authenticated by an external authentication entity that is external to the wireless communication system. The first core network node transmits a second authentication request toward the external authentication entity, the second authentication request identifying the UE, and receives a first authentication response verifying authenticity of the UE. The method further includes obtaining a key for securing communications with the UE based on the authentication response, and transmitting a second authentication response to the second core network node, the second authentication response identifying the UE and including the key for securing communications with the UE.

In some embodiments, determining that the UE should be authenticated by the external authentication entity includes transmitting an authentication get request to a third core network node in response to receiving the first authentication request, and receiving an authentication get response from the third core network node including an authentication profile for the UE. The authentication profile for the UE indicates that the UE should be authenticated by the external authentication entity.

In some embodiments, the core network includes a 5GC core network, and the third core network node implements a Unified Data Management, UDM, function. In some embodiments, first core network node implements an Authentication Server Function, AUSF, and the second core network node implements an Access and Mobility Management Function, AMF. The wireless communication system may include a standalone non-public network.

In some embodiments, the first authentication request includes a subscriber concealed identity, SUCI, of the UE, the method further includes determining a subscriber permanent identity, SUPI, of the UE. Determining that the UE should be authenticated by the external authentication entity may be performed based on the SUCI or the SUPI of the UE, the second authentication request includes the SUPI of the UE.

In some embodiments, the first authentication request includes a serving network name, SNN, associated with the UE, and the second authentication request includes the SNN.

In some embodiments, the first core network node implements an Authentication Server Function, AUSF, and the key for securing communications with the UE includes a security anchor function, SEAF, security key, KSEAF. The SEAF security key KSEAF may be included in the first authentication response.

In some embodiments, the first authentication response includes an AUSF security key, KAUSF, and the method further includes deriving the SEAF key KSEAF from the AUSF security key, KAUSF.

In some embodiments, determining that the UE should be authenticated by the external authentication entity is performed according to a predetermined static configuration.

In some embodiments, the second authentication request and the first authentication response include hypertext transfer protocol, HTTP, messages. In some embodiments, the second authentication request and the first authentication response include Diameter protocol commands.

Some embodiments provide a method performed by a core network node of a core network of a wireless communication system for authenticating a user equipment, UE, to the core network. The method includes receiving a registration request from the UE, transmitting, towards an external authentication entity that is external to the core network, an authentication request to authenticate the UE to the core network, the first authentication request identifying the UE, receiving an authentication response verifying authenticity of the UE and including a key for securing communications with the UE, and performing a Security Mode Command, SMC, procedure with the UE using the key for securing communications with the UE.

In some embodiments, the key for securing communications with the UE includes a security anchor function, SEAF, security key, KSEAF.

In some embodiments, the external authentication entity implements an external Authentication Server Function, AUSF, that is outside the core network, and the network node implements a Unified Data Management, UDM, function.

Some embodiments provide a method performed by a first core network node of a core network of a wireless communication system for authenticating a user equipment, UE, to the core network. The method includes receiving, from a second core network node, a first authentication request to authenticate the UE to the core network, the first authentication request identifying the UE, determining that the UE should be authenticated by an external authentication entity that is external to the wireless communication system, and transmitting a second authentication request toward the external authentication entity, the second authentication request identifying the UE.

Determining that the UE should be authenticated by the external authentication entity includes transmitting an authentication request to a third core network node in response to receiving the first authentication request, and receiving an authentication response from the third core network node. The authentication get response indicates that the UE should be authenticated by the external authentication entity.

In some embodiments, the authentication request includes an authentication get request, the third core network node implements a unified data management, UDM, function of the core network, and the authentication response includes an authentication get response.

In some embodiments, the core network includes a 5GC core network, the first core network node implements an Authentication Server Function, AUSF, and the second core network node implements an Access and Mobility Management Function, AMF.

In some embodiments, the first authentication request includes a subscriber concealed identity, SUCI, of the UE, and the method further includes determining a subscriber permanent identity, SUPI, of the UE. Determining that the UE should be authenticated by the external authentication entity may be performed based on the SUCI or the SUPI of the UE, the second authentication request may include the SUPI of the UE.

In some embodiments, the first authentication request includes a serving network name, SNN, associated with the UE, and the second authentication request includes the SNN.

Some embodiments provide a method performed by a third core network node of a core network of a wireless communication system for authenticating a user equipment, UE, to the core network. The method includes receiving an authentication request from a first core network node, and transmitting an authentication response to the first core network node, the authentication response indicates that the UE should be authenticated by the external authentication entity.

In some embodiments, the third core network node implements a unified data management, UDM, function of the core network, the first core network implements an Authentication Server Function, AUSF, of the core network, the authentication request includes an authentication get request, and the authentication response includes an authentication get response.

Some embodiments provide a network node including a processor circuit, a network interface coupled to the processor circuit, and a memory coupled to the processor circuit, the memory including machine readable program instructions that, when executed by the processor circuit, cause the network node to perform operations according to any of the described embodiments.

Some embodiments provide a computer program product including a non-transitory computer readable storage medium including computer readable program code embodied in the medium that when executed by a processor circuit of a network node causes the cause the network node to perform operations according to any of any of the described embodiments.

Some embodiments described herein facilitate the establishment of security keys between the UE and the network using an external AAA server acting as an (external) AUSF while reducing or avoiding impact on the UE. Some embodiments described herein may have certain advantages. For example, some embodiments may facilitate the establishment of security keys for the protection of the control and user plane traffic in a way that does not impact the UE and that reduces/minimizes the impact on the primary authentication framework at the cost of minor enhancements on the network side.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 illustrates a wireless communication system.

FIG. 2 illustrates a reference architecture of a wireless communication system including a radio access network and a core network.

FIG. 3 illustrates a hierarchy of security keys generated as part of an authentication process.

FIG. 4 illustrates an EAP authentication process.

FIG. 5 illustrates an authentication process according to some embodiments.

FIG. 6 illustrates an authentication get request and response according to some embodiments.

FIGS. 7 and 8 illustrate authentication processes according to further embodiments.

FIGS. 9, 10 and 11 are flow charts illustrating operations of a core network node according to some embodiments.

FIG. 12 is a block diagram illustrating an example of a user equipment (UE) node according to some embodiments.

FIG. 13 is a block diagram illustrating an example of a radio access network (RAN) node according to some embodiments.

FIG. 14 is a block diagram of a wireless network in accordance with some embodiments.

FIG. 15 is a block diagram of a user equipment in accordance with some embodiments

FIG. 16 is a block diagram of a virtualization environment in accordance with some embodiments.

FIG. 17 is a block diagram of a telecommunication network connected via an intermediate network to a host computer in accordance with some embodiments.

FIG. 18 is a block diagram of a host computer communicating via a base station with a user equipment over a partially wireless connection in accordance with some embodiments.

FIG. 19 is a block diagram of methods implemented in a communication system including a host computer, a base station, and a user equipment in accordance with some embodiments.

FIG. 20 is a block diagram of methods implemented in a communication system including a host computer, a base station, and a user equipment in accordance with some embodiments.

FIG. 21 is a block diagram of methods implemented in a communication system including a host computer, a base station, and a user equipment in accordance with some embodiments; and

FIG. 22 is a block diagram of methods implemented in a communication system including a host computer, a base station, and a user equipment in accordance with some embodiments.

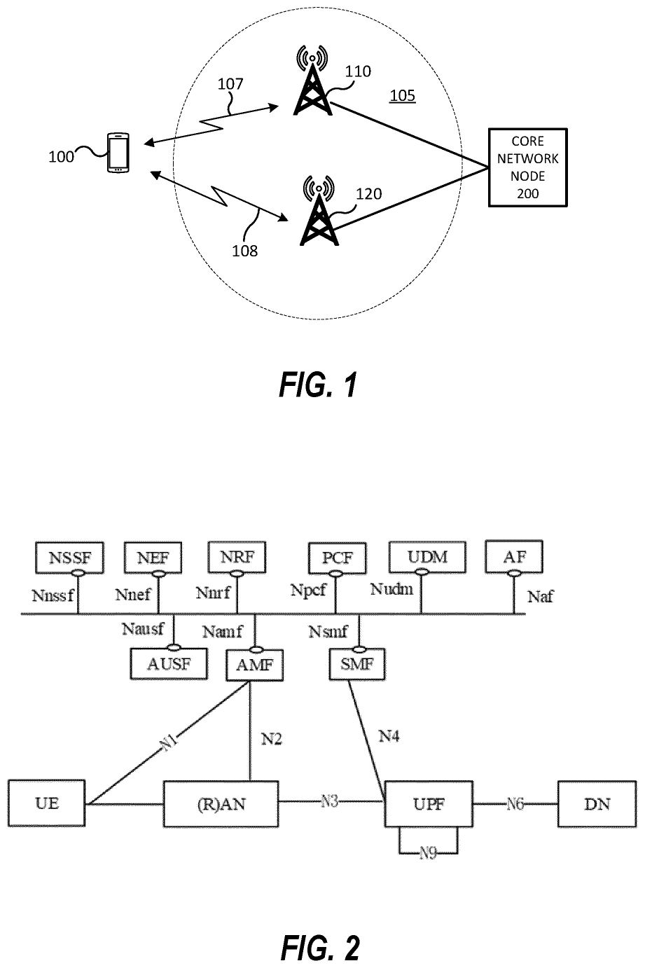

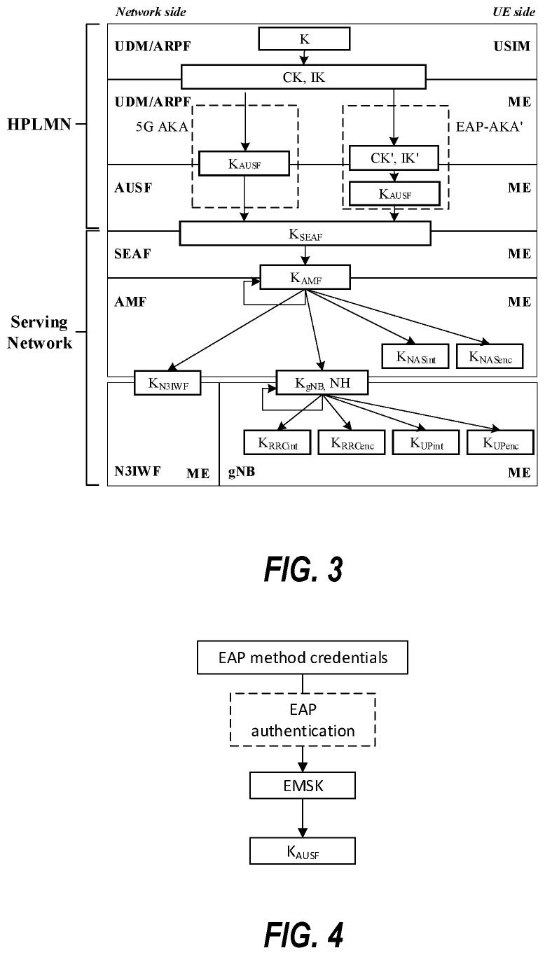

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

In the following discussion, the term “default UE credentials” refers to information that the UE has before the actual onboarding procedure to make it uniquely identifiable and verifiably secure. The Default Credential Server (DCS) is the server that can authenticate a UE with default UE credentials or provide means to another entity to do it. The term “NPN credentials” refers to information that the UE uses for authentication to access a NPN. NPN credentials may be 3GPP credentials or non-3GPP credentials. The Onboarding Network (ON) is the network providing initial registration and/or access to the UE for UE Onboarding. The Provisioning Server (PS) is the server that provisions the authenticated/authorized UE with the subscription data and optionally other configuration information. The Subscription Owner (SO) is the entity that stores and as result of the UE

Onboarding procedures provide the subscription data and optionally other configuration information via the PS to the UE. UE Onboarding refers to the provisioning of information, to a UE and within the network, required for the UE to get authorized access and connectivity to an NPN. A unique UE identifier Identifies the UE in the network and the DCS, and is assigned and configured by the DCS.

In relation to the study objective in TR 23.700-7 [1], for the onboarding feature, the DCS is the external entity that is expected to authenticate the UE for a given network based on the Default UE credentials. One of the use cases of such delegated authentication procedure is UE onboarding. It may be assumed that the onboarding network relies on such an external DCS to grant temporary access and connectivity to UEs for onboarding. Once the UE is provisioned with the necessary credentials, the UE can use the new credentials to access the target NPN.

Currently there are no specified mechanisms by which the UE can establish security keys with the network in case the network relies on the DCS for UE authentication. If no keys are established with the network in question, then all control and user plane traffic will be unprotected over the air interface. While this could be acceptable for temporary access such as for the onboarding case, it can only be beneficial for the system to support security establishment mechanisms even though the authenticating entity is external to the network.

In particular, Key Issue #1 in TR 23.700-07 [1] studies enhancements to enable support for SNPNs along with subscriptions or credentials owned by an entity separate from the SNPN. Some solutions to this issue, are based on the interworking of the 5GC with an external Authentication, Authorization, Accounting (AAA) server. For example, solution #8 in TR 23.700-07 [1] enables UEs to access an SNPN which makes use of a credential management system managed by a credential provider external to the SNPN. The credential management functionality provided by the external credential provider includes handling of identifiers and corresponding security material used to identify the devices used within the SNPN and to mutually authenticate these devices and the SNPN 5GS. The credential provider will typically correspond with an already existing credential management system (i.e. an AAA system) owned by the vertical owner of the SNPN 5GS.

Some embodiments described herein facilitate the establishment of security keys between the UE and the network using an external AAA server acting as an (external) AUSF while reducing or avoiding impact on the UE. Some embodiments described herein may have certain advantages. For example, some embodiments may facilitate the establishment of security keys for the protection of the control and user plane traffic in a way that does not impact the UE and that reduces/minimizes the impact on the primary authentication framework at the cost of minor enhancements on the network side.

Some embodiments described herein employ an external AAA that supports AUSF functionality as defined by 3GPP TS 33.501 [4]. Some embodiments rely on existing primary authentication procedures, except that the AUSF in the SNPN acts as an authentication proxy rather than as the authentication server.

Moreover, some embodiments assume that a key-generating EAP method is used during the primary authentication EAP round resulting in the establishment of the MSK and EMSK keys between the external AUSF and the UE as shown in FIG. 4. The EMSK is used to derive the necessary keys for the protection of the control and user plane traffic as described in TS 33.501 [4] for the EAP based authentication and without any impact on the UE side.

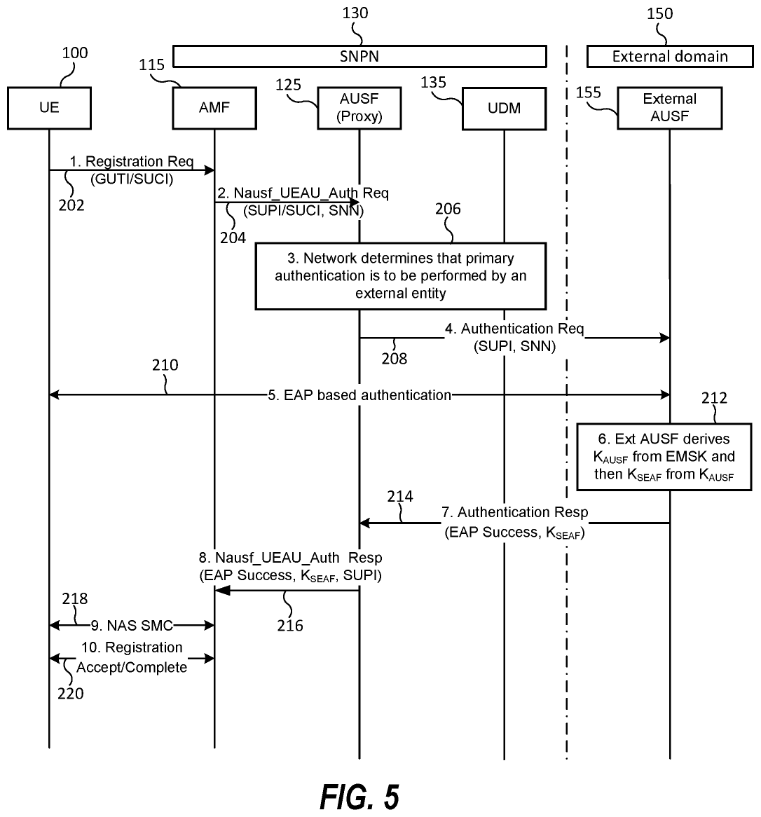

FIG. 5 illustrates an authentication procedure according to some embodiments. Referring to FIG. 5, authentication operations according to some embodiments can authenticate a UE 100 to an SNPN 130 that includes an AMF 115, a local AUSF 125 (acting as an AUSF proxy in some embodiments), and a UDM 135. An external AUSF 155 is provided in an external domain 150 outside the SNPN 130. It will be appreciated that the networks illustrated in FIG. 5 may include other nodes and/or functions, including intermediate node and/or functions. Moreover, the names of the nodes/functions shown in FIG. 5 are provided for illustrative purposes and may be different from those shown in a particular environment.

Referring to FIG. 5, in a first step 1, the UE 100 initiates a registration procedure by sending a Registration Request message 202 to the AMF 115. The Registration Request message 202 may include a subscription concealed identifier (SUCI) that identifies the UE 100.

In step 2, the AMF 115 triggers an authentication procedure by sending a first authentication request 204 to the local AUSF 125 (acting as a proxy in this example). The first authentication request 204 may be a Nausf_UEAuthentication_Authenticate Request that includes including the UE's SUCI (or subscription permanent identifier, SUPI, obtained using the SUCI) and the Serving Network name (SNN) to the local AUSF 125 within the SNPN 130 as currently defined in TS 33.501 [4].

In step 3, the SNPN 130 determines at block 206 that primary authentication is to be performed by an external entity. To perform this determination, the local AUSF 125 may check with the UDM 135 as described in more detail below. If the SUCI was provided by the AMF 115 in the first authentication request 204, then the UDM 135 resolve the UE's SUPI based on the SUCI.

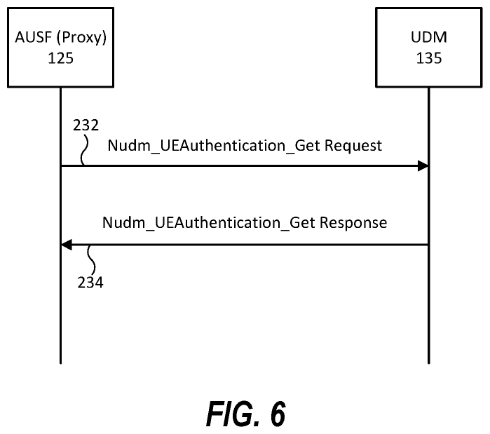

In some embodiments, the local AUSF 125 may check with the UDM 135 to determine the authentication method applicable for the UE 100 using the Nudm_UEAuthentication_Get service operation as defined in TS 33.501 [4]. Brief reference is made to FIG. 6, which illustrates the ASUF 125 and the UDM 135 in the SNPN 130. According to these embodiments, an authentication subscription profile stored at the UDM 135 (or the associated unified data repository (UDR)) includes an indication that authentication of the UE 100 should be executed with an external AUSF 155. The local AUSF 125 transmits an authentication get request 232 (e.g., Nudm_UEAuthentication_Get Request) to the UDM 135, which responds with an authentication get response 234 (e.g., Nudm_UEAuthentication_Get Response). The indication that authentication of the UE 100 should be executed with the external AUSF 155 is included in the authentication get response 234.

In further embodiments, the SNPN 130 (and in particular the local AUSF 125) may be preconfigured to perform external authentication using the external AUSF 155 based on specific values of the SUCI signaled by the UE 100, such as a particular routing indicator or a particular range of domain names in the SUPI in case it is in NAI format. For example, the local AUSF 125 may be configured to act as a proxy for all SUPI/SUCIs of a predetermined realm.

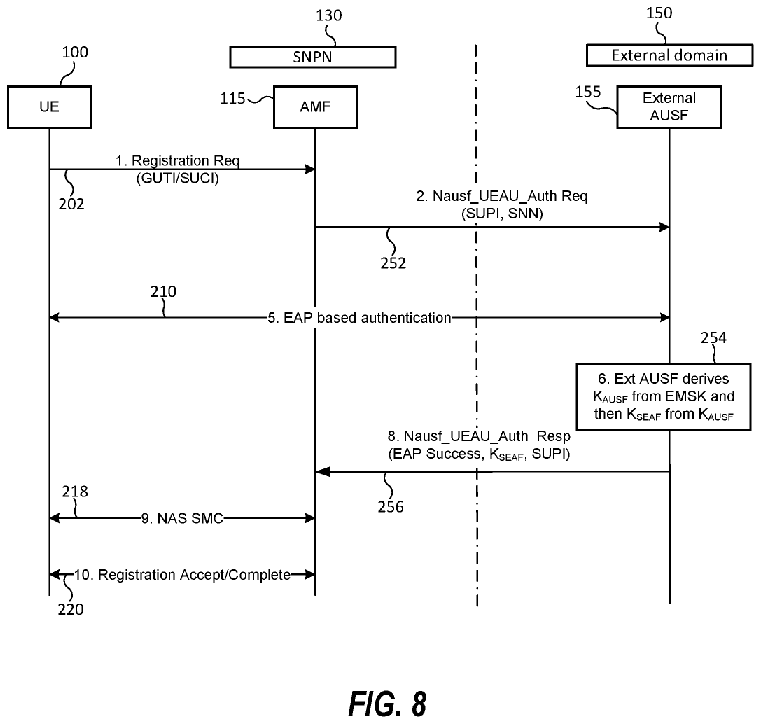

In another example, the AMF 115 in the SNPN 130 may be configured to directly contact the external AUSF 155 by sending the SUPI/SUCI and SNN in an authentication request to the external AUSF 155, as described in more detail below in connection with FIG. 8.

Referring again to FIG. 5, in step 4, the local AUSF 125 acts as an authentication proxy/EAP authenticator (AUSF proxy) for the first authentication request 204. In particular, the local AUSF 125 proxies the first authentication request 204 in a second authentication request 208, including the SNN and the SUCI or SUPI of the UE 100, to the external AUSF 155. In some cases, SUCI de-concealment may be performed by the external AUSF 155. In that case, the second authentication request 208 includes the SUCI instead of the SUPI.

In step 5, the UE 100 and the external AUSF 155 engage in an EAP exchange 210. In the EAP exchange 210, the messages are relayed to the UE 100 through the local AUSF 125 and the AMF 115.

In step 6, a successful EAP authentication process leads to the establishment of the MSK and EMSK keys between the UE 100 and the external AUSF 155. At block 212, the external AUSF 155 derives the K_{AUSF} key from the EMSK, and then the K_{SEAF} key from the K_{AUSF} key, using the received SNN as described in Annex B of TS.33.501 [4].

In step 7, the external AUSF 155 then sends a first authentication response 214 including the K_{SEAF} key alongside other parameters, such as an EAP Success message and possibly the SUPI to the local AUSF 125.

In some embodiments, the second authentication request 208 and the first authentication response 214 may be the Nausf_UEAuthentication_Authenticate service operations defined in TS 33.501 [4].

In other embodiments, the second authentication request 208 and the first authentication response 214 may be realized using new service-based service operations defined in accordance with the service based architecture requirements and formats used within the 5G Core as defined, for example, in TS 23.502 [6]. In that case, the second authentication request 208 and the first authentication response 214 would be hypertext transfer protocol (HTTP) messages.

In yet further embodiments, the second authentication request 208 and the first authentication response 214 may be realized by new attribute-value pairs (AVPs) in the Diameter protocol described in RFC 6733 [2]. In that case, the local AUSF 125 may translate the authentication service operations into Diameter commands, and vice-versa.

In step 8, the local AUSF 125 sends a second authentication response 216 to the AMF 115 including the K_{SEAF} key and the SUPI.

In step 9, the AMF 115 and UE 100 perform a NAS security mode command (SMC) procedure for NAS security establishment as described in TS 33.501 [4]. Once NAS security is activated, all subsequent NAS messages to/from the UE 100 will be integrity and confidentiality protected.

In step 10, the registration procedure continues and eventually is completed by the AMF 115 sending a Registration Accept message 220 and the UE 100 optionally responding with a Registration Complete message.

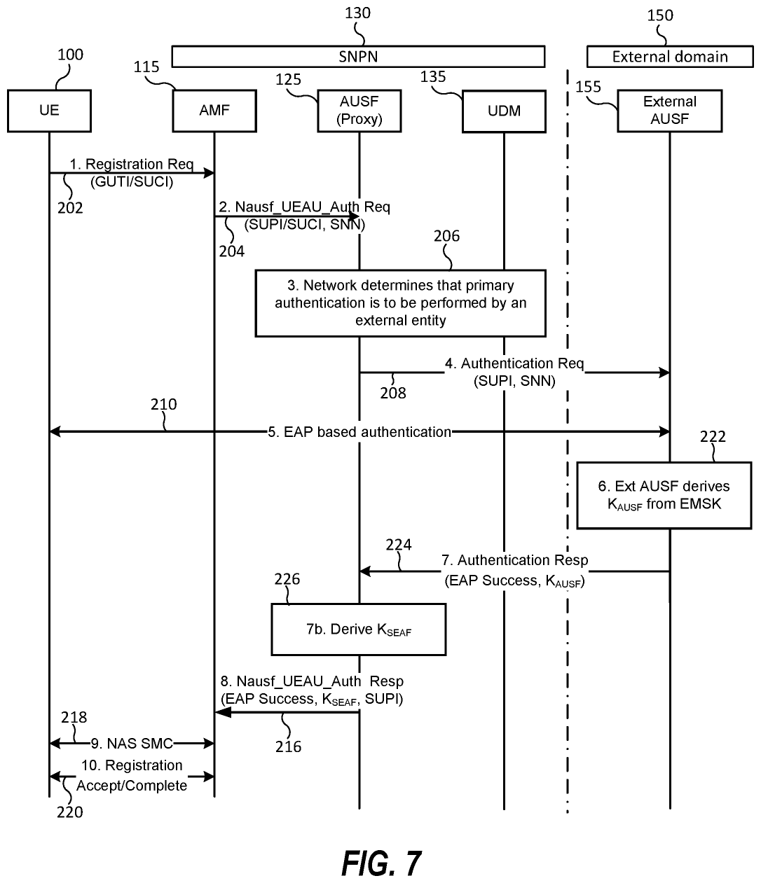

FIG. 7 illustrates an authentication procedure according to further embodiments. The procedure illustrated in FIG. 7 is similar to the procedure illustrated in FIG. 5, except that in the procedure of FIG. 7, upon completion of the EAP based authentication procedure 210 in step 5, the external AUSF 155 derives the K_{AUSF} key from the MSK key in block 222 (step 6) and sends the K_{AUSF} key in a first authentication response message 224 to the local AUSF 125 (step 7). That is, in the embodiments of FIG. 7, the external AUSF 155 does not derive the K_{SEAF} key or send the K_{SEAF} key to the local AUSF 125. Providing the K_{AUSF} key to the local AUSF 125 allows the SNPN 130 to keep an authentication context of the UE 100 including the K_{AUSF} key and to use this information in subsequent procedures where the K_{AUSF} key is needed without the need to engage in further interactions with the external AUSF 155.

FIG. 8 illustrates an authentication procedure according to further embodiments. In the embodiments of FIG. 8, the AMF 115 in the SNPN 130 is configured to directly contact the external AUSF 155 by sending the SUPI/SUCI and SNN directly to the external AUSF 155 in an authentication request 252. At block 254, the external AUSF 155 derives the K_{AUSF} key from the EMSK, and then the K_{SEAF} key from the K_{AUSF} key. The external AUSF 155 then sends an authentication response 256 directly to the AMF 115 including the K_{SEAF} key and the SUPI of the UE 100. The remaining procedures are similar to those illustrated in FIG. 5.

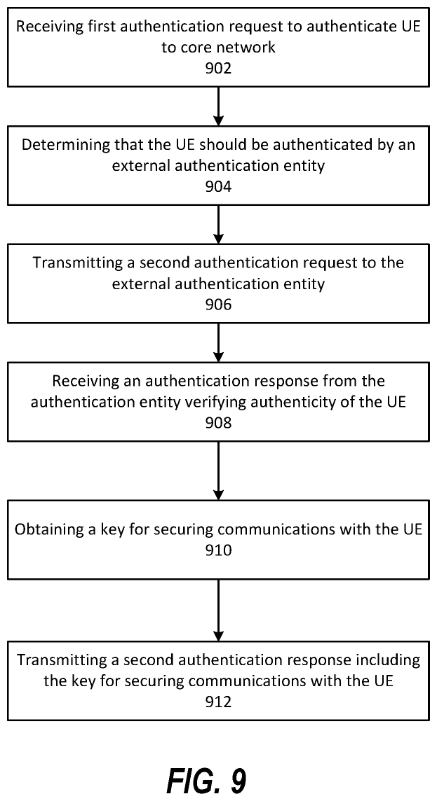

Operations of a first core network function according to some embodiments are illustrated in FIG. 9. As shown therein, a method by a first core network node of a core network of a wireless communication system for authenticating a user equipment, UE, to the core network includes receiving (block 902), from a second core network node, a first authentication request to authenticate the UE to the core network, the first authentication request identifying the UE, and determining (block 904) that the UE should be authenticated by an external authentication entity that is external to the wireless communication system.

The methods further include transmitting (block 906) a second authentication request to the external authentication entity, the second authentication request identifying the UE, and receiving (block 908) a first authentication response from the authentication entity verifying authenticity of the UE.

The methods further include obtaining (block 910) a key for securing communications with the UE based on the authentication response, and transmitting (block 912) a second authentication response to the second core network node, the second authentication response identifying the UE and including the key for securing communications with the UE.

The core network may be a 5GC core network, and the third core network node may implement a Unified Data Management, UDM, function.

The first core network node may implement an Authentication Server Function, AUSF, and the second core network node may implement an Access and Mobility Management Function, AMF.

The wireless communication system may be a standalone non-public network.

The first authentication request may be a subscriber concealed identity, SUCI, of the UE, and the method may further include determining a subscriber permanent identity, SUPI, of the UE. Determining that the UE should be authenticated by the external authentication entity may be performed based on the SUCI or the SUPI of the UE, and the second authentication request may include the SUPI of the UE.

The first authentication request may include a serving network name, SNN, associated with the UE, and the second authentication request may include the SNN.

The first core network node may implement an Authentication Server Function, AUSF, and the key for securing communications with the UE may be a security anchor function, SEAF, security key, K_{SEAF}. The SEAF security key K_{SEAF} may be included in the first authentication response.

In some embodiments, the first authentication response 224 may include an AUSF security key, K_{AUSF}, and the method may include deriving the SEAF key K_{SEAF} from the AUSF security key, K_{AUSF}.

Determining that the UE should be authenticated by the external authentication entity may be performed according to a predetermined static configuration.

The second authentication request and the first authentication response may be hypertext transfer protocol, HTTP, messages.

The second authentication request and the first authentication response may be Diameter protocol commands.

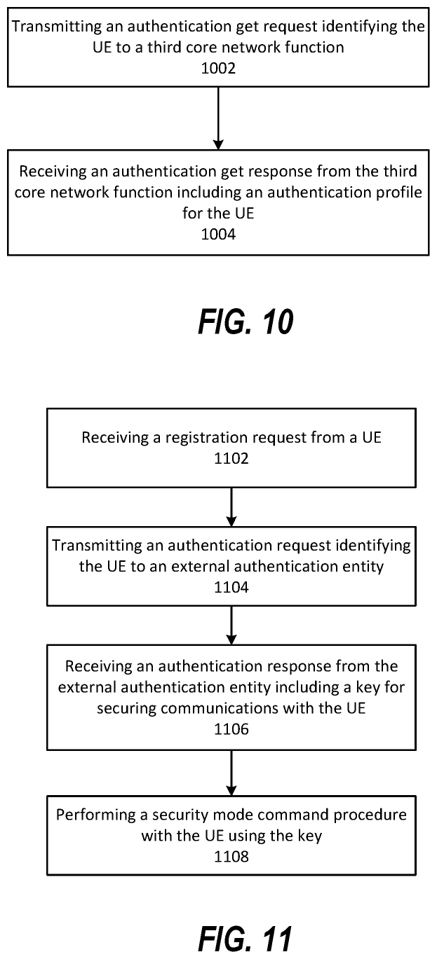

Referring to FIG. 10, determining that the UE should be authenticated by the external authentication entity may include transmitting (block 1002) an authentication get request 232 to a third core network function 135 in response to receiving the first authentication request, and receiving (block 1004) an authentication get response 234 from the third core network function comprising an authentication profile for the UE, wherein the authentication profile for the UE indicates that the UE should be authenticated by the external authentication entity.

Operations of a core network node according to further embodiments are illustrated in FIG. 11. As shown therein, a method by a core network node 115 of a core network 130 of a wireless communication system for authenticating a user equipment 100, UE, to the core network includes receiving (block 1102) a registration request 202 from the UE, and transmitting (block 1104), to an external authentication entity 155 that is external to the core network, an authentication request 252 to authenticate the UE to the core network, the first authentication request identifying the UE.

The methods further include receiving (block 1106) an authentication response 256 from the external authentication entity verifying authenticity of the UE and including a key for securing communications with the UE, and performing (block 1108) a Security Mode Command, SMC, procedure with the UE using the key for securing communications with the UE.

The key for securing communications with the UE may be a security anchor function, SEAF, security key, K_{SEAF}. The external authentication entity may be an external Authentication Server Function, AUSF, that is outside the core network.

The core network node 115 may implement a UDM function of the core network.

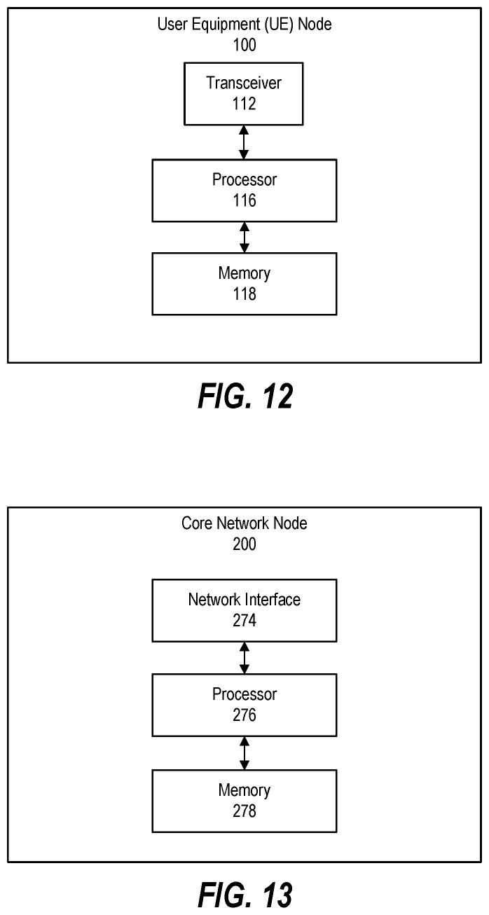

FIG. 12 depicts an example of a UE 100 of a wireless communication network configured to provide wireless communication according to embodiments of inventive concepts. As shown, the UE 100 may include a transceiver circuit 112 (also referred to as a transceiver) including a transmitter and a receiver configured to provide uplink and downlink radio communications with wireless devices. The UE 100 may also include a processor circuit 116 (also referred to as a processor) coupled to the transceiver circuit 112, and a memory circuit 118 (also referred to as memory) coupled to the processor circuit 116. The memory circuit 118 may include computer readable program code that when executed by the processor circuit 116 causes the processor circuit to perform operations according to embodiments disclosed herein. According to other embodiments, processor circuit 116 may be defined to include memory so that a separate memory circuit is not required.

As discussed herein, operations of the UE 100 may be performed by processor 116 and/or transceiver 112. For example, the processor 116 may control transceiver 112 to transmit uplink communications through transceiver 112 over a radio interface to one or more network nodes and/or to receive downlink communications through transceiver 112 from one or more network nodes over a radio interface. Moreover, modules may be stored in memory 118, and these modules may provide instructions so that when instructions of a module are executed by processor 116, processor 116 performs respective operations (e.g., operations discussed above with respect to example embodiments).

Accordingly, a UE 100 according to some embodiments includes a processor circuit 116, a transceiver 112 coupled to the processor circuit, and a memory 118 coupled to the processor circuit, the memory including machine readable program instructions that, when executed by the processor circuit, cause the UE 100 to perform operations described above.

FIG. 13 is a block diagram of a network node according to some embodiments. Various embodiments provide a core network node that includes a processor circuit 276 and a memory 278 coupled to the processor circuit. The memory 278 includes machine-readable computer program instructions that, when executed by the processor circuit, cause the processor circuit to perform some of the operations depicted in FIGS. 9 to 11.

FIG. 13 depicts an example of a core network node 200 of a wireless communication network configured to provide cellular communication according to embodiments of inventive concepts. The core network node 200 may include a network interface circuit 274 (also referred to as a network interface) configured to provide communications with other nodes (e.g., with other base stations and/or core network nodes) of the wireless communication network. The memory circuit 278 may include computer readable program code that when executed by the processor circuit 276 causes the processor circuit to perform operations according to embodiments disclosed herein. According to other embodiments, processor circuit 276 may be defined to include memory so that a separate memory circuit is not required.

As discussed herein, operations of the core network node 200 may be performed by processor 276 and/or network interface 274. For example, processor 276 may control network interface 204 to transmit communications through network interface 234 to one or more other network nodes and/or to receive communications through network interface from one or more other network nodes. Moreover, modules may be stored in memory 278, and these modules may provide instructions so that when instructions of a module are executed by processor 276, processor 276 performs respective operations. In addition, a structure similar to that of FIG. 13 may be used to implement other network nodes. Moreover, network nodes discussed herein may be implemented as virtual network nodes. It will be appreciated that a single physical network node 200 may implement one or more of the core network functions of a core network, such as the AMF, UDM, AUSF, SMF, PCF, etc. In such case, each function may be viewed from the network perspective as an independent virtual network node in the core network.

Referring to FIGS. 9 and 13, in some embodiments, a first core network node 200 in a wireless communication system according to some embodiments includes a processor circuit 276, a network interface 274 coupled to the processor circuit, and a memory 278 coupled to the processor circuit, the memory comprising machine readable program instructions that, when executed by the processor circuit, cause the network node to perform operations of receiving (block 902), from a second core network node 115, a first authentication request 204 to authenticate the UE to the core network, the first authentication request identifying the UE, and determining (block 904) that a UE should be authenticated by an external authentication entity 155 that is external to the wireless communication system.

The operations further include transmitting (block 906) a second authentication request 208 to the external authentication entity, the second authentication request identifying the UE, and receiving (block 908) a first authentication response 214, 224 from the authentication entity verifying authenticity of the UE.

The operations further include obtaining (block 910) a key for securing communications with the UE based on the authentication response, and transmitting (block 912) a second authentication response 216 to the second core network node, the second authentication response identifying the UE and including the key for securing communications with the UE.

Referring to FIGS. 11 and 13, in some embodiments, a network node 200 in a wireless communication system according to some embodiments includes a processor circuit 276, a network interface 274 coupled to the processor circuit, and a memory 278 coupled to the processor circuit, the memory comprising machine readable program instructions that, when executed by the processor circuit, cause the network node to perform operations of receiving (block 1102) a registration request 202 from a UE, and transmitting (block 1104), to an external authentication entity 155 that is external to the core network, an authentication request 252 to authenticate the UE to the core network, the first authentication request identifying the UE.

The operations further include receiving (block 1106) an authentication response 256 from the external authentication entity verifying authenticity of the UE and including a key for securing communications with the UE, and performing (block 1108) a Security Mode Command, SMC, procedure with the UE using the key for securing communications with the UE.

### LISTING OF EXAMPLE EMBODIMENTS

Example Embodiments are discussed below. Reference numbers/letters are provided in parenthesis by way of example/illustration without limiting example embodiments to particular elements indicated by reference numbers/letters.

Embodiment 1. A method by a first core network node (125) of a core network (130) of a wireless communication system for authenticating a user equipment (100), UE, to the core network, the method comprising:
receiving (902), from a second core network node (115), a first authentication request (204) to authenticate the UE to the core network, the first authentication request identifying the UE;
determining (904) that the UE should be authenticated by an external authentication entity (155) that is external to the wireless communication system;
transmitting (906) a second authentication request (208) to the external authentication entity, the second authentication request identifying the UE;
receiving (908) a first authentication response (214, 224) from the authentication entity verifying authenticity of the UE;
obtaining (910) a key for securing communications with the UE based on the authentication response; and
transmitting (912) a second authentication response (216) to the second core network node, the second authentication response identifying the UE and including the key for securing communications with the UE.

Embodiment 2. The method of Embodiment 1, wherein determining that the UE should be authenticated by the external authentication entity comprises:
transmitting (1002) an authentication get request (232) to a third core network node (135) in response to receiving the first authentication request; and
receiving (1004) an authentication get response (234) from the third core network node comprising an authentication profile for the UE, wherein the authentication profile for the UE indicates that the UE should be authenticated by the external authentication entity.

Embodiment 3. The method of Embodiment 2, wherein the core network comprises a 5GC core network, and wherein the third core network node implements a Unified Data Management, UDM, function.

Embodiment 4. The method of any previous Embodiment, wherein the core network comprises a 5GC core network, wherein the first core network node implements an Authentication Server Function, AUSF, and wherein the second core network node implements an Access and Mobility Management Function, AMF.

Embodiment 5. The method of any preceding embodiment, wherein the wireless communication system comprises a standalone non-public network.

Embodiment 6. The method of any preceding Embodiment, wherein the first authentication request includes a subscriber concealed identity, SUCI, of the UE, the method further comprising:
determining a subscriber permanent identity, SUPI, of the UE, wherein determining that the UE should be authenticated by the external authentication entity is performed based on the SUCI or the SUPI of the UE, wherein the second authentication request includes the SUPI of the UE.

Embodiment 7. The method of any preceding embodiment, wherein the first authentication request comprises a serving network name, SNN, associated with the UE, and wherein the second authentication request includes the SNN.

Embodiment 8. The method of any previous Embodiment, wherein:
the first core network node implements an Authentication Server Function, AUSF; and
the key for securing communications with the UE comprises a security anchor function, SEAF, security key, K_{SEAF}.

Embodiment 9. The method of Embodiment 8, wherein the SEAF security key K_{SEAF} is included in the first authentication response.

Embodiment 10. The method of Embodiment 8, wherein:
the first authentication response (224) includes an AUSF security key, K_{AUSF}, the method further comprising deriving (226) the SEAF key K_{SEAF} from the AUSF security key, K_{AUSF}.

Embodiment 11. The method of any previous Embodiment, wherein determining that the UE should be authenticated by the external authentication entity is performed according to a predetermined static configuration.

Embodiment 12. The method of any previous Embodiment, wherein the second authentication request and the first authentication response comprise hypertext transfer protocol, HTTP, messages.

Embodiment 13. The method of any of Embodiments 1 to 12, wherein the second authentication request and the first authentication response comprise Diameter protocol commands.

Embodiment 14. A method by a core network node (115) of a core network (130) of a wireless communication system for authenticating a user equipment (100), UE, to the core network, the method comprising:
receiving (1102) a registration request (202) from the UE;
transmitting (1104), to an external authentication entity (155) that is external to the core network, an authentication request (252) to authenticate the UE to the core network, the first authentication request identifying the UE;
receiving (1106) an authentication response (256) from the external authentication entity verifying authenticity of the UE and including a key for securing communications with the UE; and
performing (1108) a Security Mode Command, SMC, procedure with the UE using the key for securing communications with the UE.

Embodiment 15. The method of Embodiment 14, wherein the key for securing communications with the UE comprises a security anchor function, SEAF, security key, K_{SEAF}

Embodiment 16. The method of Embodiment 14 or 15, wherein the external authentication entity implements an external Authentication Server Function, AUSF, that is outside the core network.

Embodiment 17. The method of any of Embodiments 14 to 16, wherein the network node implements a Unified Data Management, UDM, function.

Embodiment 18. A network node (200), comprising:
a processor circuit (276);
a network interface (274) coupled to the processor circuit; and
a memory (278) coupled to the processor circuit, the memory comprising machine readable program instructions that, when executed by the processor circuit, cause the network node to perform operations according to any of Embodiments 1 to 17.

### REFERENCES

[1] TR 23.700-07
[2] RFC 6733
[3] TS 23.501 v 16.5.1
[4] TS 33.501 v 16.3.0
[5] TS 33.401 v 16.3.0
[6] TS 23.502 v 16.5.1
[7] RFC 5448, May 2009

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise.

The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

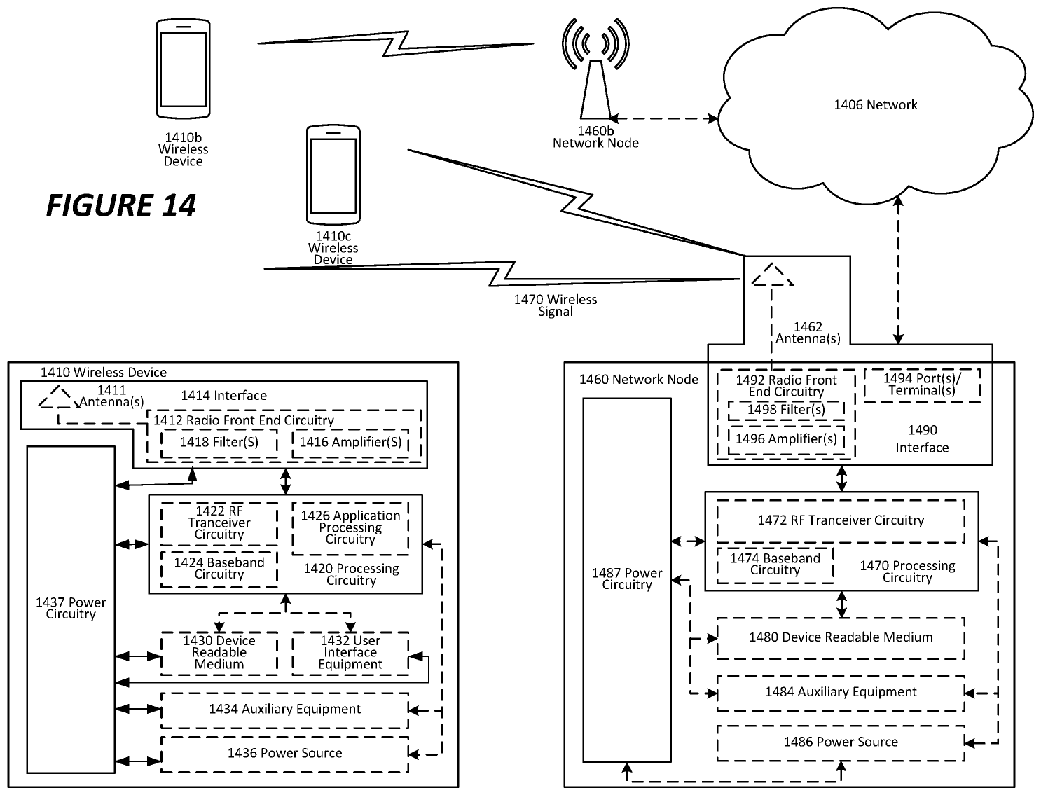

FIG. 14: A wireless network in accordance with some embodiments.

Although the subject matter described herein may be implemented in any appropriate type of system using any suitable components, the embodiments disclosed herein are described in relation to a wireless network, such as the example wireless network illustrated in FIG. 14. For simplicity, the wireless network of FIG. 14 only depicts network 1406, network nodes 1460 and 1460b, and WDs 1410, 1410b, and 1410c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 1460 and wireless device (WD) 1410 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1406 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1460 and WD 1410 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 14, network node 1460 includes processing circuitry 1470, device readable medium 1480, interface 1490, auxiliary equipment 1484, power source 1486, power circuitry 1487, and antenna 1462. Although network node 1460 illustrated in the example wireless network of FIG. 14 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1460 are depicted as single boxes located within a larger box, or nested within multiple boxes, in practice, a network node may comprise multiple different physical components that make up a single illustrated component (e.g., device readable medium 1480 may comprise multiple separate hard drives as well as multiple RAM modules).

Similarly, network node 1460 may be composed of multiple physically separate components (e.g., a NodeB component and a RNC component, or a BTS component and a BSC component, etc.), which may each have their own respective components. In certain scenarios in which network node 1460 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1460 may be configured to support multiple radio access technologies (RATs). In such embodiments, some components may be duplicated (e.g., separate device readable medium 1480 for the different RATs) and some components may be reused (e.g., the same antenna 1462 may be shared by the RATs). Network node 1460 may also include multiple sets of the various illustrated components for different wireless technologies integrated into network node 1460, such as, for example, GSM, WCDMA, LTE, NR, WiFi, or Bluetooth wireless technologies. These wireless technologies may be integrated into the same or different chip or set of chips and other components within network node 1460.

Processing circuitry 1470 is configured to perform any determining, calculating, or similar operations (e.g., certain obtaining operations) described herein as being provided by a network node. These operations performed by processing circuitry 1470 may include processing information obtained by processing circuitry 1470 by, for example, converting the obtained information into other information, comparing the obtained information or converted information to information stored in the network node, and/or performing one or more operations based on the obtained information or converted information, and as a result of said processing making a determination.

Processing circuitry 1470 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1460 components, such as device readable medium 1480, network node 1460 functionality. For example, processing circuitry 1470 may execute instructions stored in device readable medium 1480 or in memory within processing circuitry 1470. Such functionality may include providing any of the various wireless features, functions, or benefits discussed herein. In some embodiments, processing circuitry 1470 may include a system on a chip (SOC).

In some embodiments, processing circuitry 1470 may include one or more of radio frequency (RF) transceiver circuitry 1472 and baseband processing circuitry 1474. In some embodiments, radio frequency (RF) transceiver circuitry 1472 and baseband processing circuitry 1474 may be on separate chips (or sets of chips), boards, or units, such as radio units and digital units. In alternative embodiments, part or all of RF transceiver circuitry 1472 and baseband processing circuitry 1474 may be on the same chip or set of chips, boards, or units.

In certain embodiments, some or all of the functionality described herein as being provided by a network node, base station, eNB or other such network device may be performed by processing circuitry 1470 executing instructions stored on device readable medium 1480 or memory within processing circuitry 1470. In alternative embodiments, some or all of the functionality may be provided by processing circuitry 1470 without executing instructions stored on a separate or discrete device readable medium, such as in a hard-wired manner. In any of those embodiments, whether executing instructions stored on a device readable storage medium or not, processing circuitry 1470 can be configured to perform the described functionality. The benefits provided by such functionality are not limited to processing circuitry 1470 alone or to other components of network node 1460, but are enjoyed by network node 1460 as a whole, and/or by end users and the wireless network generally.

Device readable medium 1480 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1470. Device readable medium 1480 may store any suitable instructions, data or information, including a computer program, software, an application including one or more of logic, rules, code, tables, etc. and/or other instructions capable of being executed by processing circuitry 1470 and, utilized by network node 1460. Device readable medium 1480 may be used to store any calculations made by processing circuitry 1470 and/or any data received via interface 1490. In some embodiments, processing circuitry 1470 and device readable medium 1480 may be considered to be integrated.

Interface 1490 is used in the wired or wireless communication of signalling and/or data between network node 1460, network 1406, and/or WDs 1410. As illustrated, interface 1490 comprises port(s)/terminal(s) 1494 to send and receive data, for example to and from network 1406 over a wired connection. Interface 1490 also includes radio front end circuitry 1492 that may be coupled to, or in certain embodiments a part of, antenna 1462. Radio front end circuitry 1492 comprises filters 1498 and amplifiers 1496. Radio front end circuitry 1492 may be connected to antenna 1462 and processing circuitry 1470. Radio front end circuitry may be configured to condition signals communicated between antenna 1462 and processing circuitry 1470. Radio front end circuitry 1492 may receive digital data that is to be sent out to other network nodes or WDs via a wireless connection. Radio front end circuitry 1492 may convert the digital data into a radio signal having the appropriate channel and bandwidth parameters using a combination of filters 1498 and/or amplifiers 1496. The radio signal may then be transmitted via antenna 1462. Similarly, when receiving data, antenna 1462 may collect radio signals which are then converted into digital data by radio front end circuitry 1492. The digital data may be passed to processing circuitry 1470. In other embodiments, the interface may comprise different components and/or different combinations of components.

In certain alternative embodiments, network node 1460 may not include separate radio front end circuitry 1492, instead, processing circuitry 1470 may comprise radio front end circuitry and may be connected to antenna 1462 without separate radio front end circuitry 1492. Similarly, in some embodiments, all or some of RF transceiver circuitry 1472 may be considered a part of interface 1490. In still other embodiments, interface 1490 may include one or more ports or terminals 1494, radio front end circuitry 1492, and RF transceiver circuitry 1472, as part of a radio unit (not shown), and interface 1490 may communicate with baseband processing circuitry 1474, which is part of a digital unit (not shown).

Antenna 1462 may include one or more antennas, or antenna arrays, configured to send and/or receive wireless signals. Antenna 1462 may be coupled to radio front end circuitry 1492 and may be any type of antenna capable of transmitting and receiving data and/or signals wirelessly. In some embodiments, antenna 1462 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1462 may be separate from network node 1460 and may be connectable to network node 1460 through an interface or port.

Antenna 1462, interface 1490, and/or processing circuitry 1470 may be configured to perform any receiving operations and/or certain obtaining operations described herein as being performed by a network node. Any information, data and/or signals may be received from a wireless device, another network node and/or any other network equipment. Similarly, antenna 1462, interface 1490, and/or processing circuitry 1470 may be configured to perform any transmitting operations described herein as being performed by a network node. Any information, data and/or signals may be transmitted to a wireless device, another network node and/or any other network equipment.

Power circuitry 1487 may comprise, or be coupled to, power management circuitry and is configured to supply the components of network node 1460 with power for performing the functionality described herein. Power circuitry 1487 may receive power from power source 1486. Power source 1486 and/or power circuitry 1487 may be configured to provide power to the various components of network node 1460 in a form suitable for the respective components (e.g., at a voltage and current level needed for each respective component). Power source 1486 may either be included in, or external to, power circuitry 1487 and/or network node 1460. For example, network node 1460 may be connectable to an external power source (e.g., an electricity outlet) via an input circuitry or interface such as an electrical cable, whereby the external power source supplies power to power circuitry 1487. As a further example, power source 1486 may comprise a source of power in the form of a battery or battery pack which is connected to, or integrated in, power circuitry 1487. The battery may provide backup power should the external power source fail. Other types of power sources, such as photovoltaic devices, may also be used.

Alternative embodiments of network node 1460 may include additional components beyond those shown in FIG. 14 that may be responsible for providing certain aspects of the network node's functionality, including any of the functionality described herein and/or any functionality necessary to support the subject matter described herein. For example, network node 1460 may include user interface equipment to allow input of information into network node 1460 and to allow output of information from network node 1460. This may allow a user to perform diagnostic, maintenance, repair, and other administrative functions for network node 1460.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1410 includes antenna 1411, interface 1414, processing circuitry 1420, device readable medium 1430, user interface equipment 1432, auxiliary equipment 1434, power source 1436 and power circuitry 1437. WD 1410 may include multiple sets of one or more of the illustrated components for different wireless technologies supported by WD 1410, such as, for example, GSM, WCDMA, LTE, NR, WiFi, WiMAX, or Bluetooth wireless technologies, just to mention a few. These wireless technologies may be integrated into the same or different chips or set of chips as other components within WD 1410.

Antenna 1411 may include one or more antennas or antenna arrays, configured to send and/or receive wireless signals, and is connected to interface 1414. In certain alternative embodiments, antenna 1411 may be separate from WD 1410 and be connectable to WD 1410 through an interface or port. Antenna 1411, interface 1414, and/or processing circuitry 1420 may be configured to perform any receiving or transmitting operations described herein as being performed by a WD. Any information, data and/or signals may be received from a network node and/or another WD. In some embodiments, radio front end circuitry and/or antenna 1411 may be considered an interface.

As illustrated, interface 1414 comprises radio front end circuitry 1412 and antenna 1411. Radio front end circuitry 1412 comprise one or more filters 1418 and amplifiers 1416. Radio front end circuitry 1412 is connected to antenna 1411 and processing circuitry 1420, and is configured to condition signals communicated between antenna 1411 and processing circuitry 1420. Radio front end circuitry 1412 may be coupled to or a part of antenna 1411. In some embodiments, WD 1410 may not include separate radio front end circuitry 1412; rather, processing circuitry 1420 may comprise radio front end circuitry and may be connected to antenna 1411. Similarly, in some embodiments, some or all of RF transceiver circuitry 1422 may be considered a part of interface 1414. Radio front end circuitry 1412 may receive digital data that is to be sent out to other network nodes or WDs via a wireless connection. Radio front end circuitry 1412 may convert the digital data into a radio signal having the appropriate channel and bandwidth parameters using a combination of filters 1418 and/or amplifiers 1416. The radio signal may then be transmitted via antenna 1411. Similarly, when receiving data, antenna 1411 may collect radio signals which are then converted into digital data by radio front end circuitry 1412. The digital data may be passed to processing circuitry 1420. In other embodiments, the interface may comprise different components and/or different combinations of components.

Processing circuitry 1420 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1410 components, such as device readable medium 1430, WD 1410 functionality. Such functionality may include providing any of the various wireless features or benefits discussed herein. For example, processing circuitry 1420 may execute instructions stored in device readable medium 1430 or in memory within processing circuitry 1420 to provide the functionality disclosed herein.

As illustrated, processing circuitry 1420 includes one or more of RF transceiver circuitry 1422, baseband processing circuitry 1424, and application processing circuitry 1426. In other embodiments, the processing circuitry may comprise different components and/or different combinations of components. In certain embodiments processing circuitry 1420 of WD 1410 may comprise a SOC. In some embodiments, RF transceiver circuitry 1422, baseband processing circuitry 1424, and application processing circuitry 1426 may be on separate chips or sets of chips. In alternative embodiments, part or all of baseband processing circuitry 1424 and application processing circuitry 1426 may be combined into one chip or set of chips, and RF transceiver circuitry 1422 may be on a separate chip or set of chips. In still alternative embodiments, part or all of RF transceiver circuitry 1422 and baseband processing circuitry 1424 may be on the same chip or set of chips, and application processing circuitry 1426 may be on a separate chip or set of chips. In yet other alternative embodiments, part or all of RF transceiver circuitry 1422, baseband processing circuitry 1424, and application processing circuitry 1426 may be combined in the same chip or set of chips. In some embodiments, RF transceiver circuitry 1422 may be a part of interface 1414. RF transceiver circuitry 1422 may condition RF signals for processing circuitry 1420.

In certain embodiments, some or all of the functionality described herein as being performed by a WD may be provided by processing circuitry 1420 executing instructions stored on device readable medium 1430, which in certain embodiments may be a computer-readable storage medium. In alternative embodiments, some or all of the functionality may be provided by processing circuitry 1420 without executing instructions stored on a separate or discrete device readable storage medium, such as in a hard-wired manner. In any of those particular embodiments, whether executing instructions stored on a device readable storage medium or not, processing circuitry 1420 can be configured to perform the described functionality. The benefits provided by such functionality are not limited to processing circuitry 1420 alone or to other components of WD 1410, but are enjoyed by WD 1410 as a whole, and/or by end users and the wireless network generally.

Processing circuitry 1420 may be configured to perform any determining, calculating, or similar operations (e.g., certain obtaining operations) described herein as being performed by a WD. These operations, as performed by processing circuitry 1420, may include processing information obtained by processing circuitry 1420 by, for example, converting the obtained information into other information, comparing the obtained information or converted information to information stored by WD 1410, and/or performing one or more operations based on the obtained information or converted information, and as a result of said processing making a determination.

Device readable medium 1430 may be operable to store a computer program, software, an application including one or more of logic, rules, code, tables, etc. and/or other instructions capable of being executed by processing circuitry 1420. Device readable medium 1430 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1420. In some embodiments, processing circuitry 1420 and device readable medium 1430 may be considered to be integrated. User interface equipment 1432 may provide components that allow for a human user to interact with WD 1410. Such interaction may be of many forms, such as visual, audial, tactile, etc. User interface equipment 1432 may be operable to produce output to the user and to allow the user to provide input to WD 1410. The type of interaction may vary depending on the type of user interface equipment 1432 installed in WD 1410. For example, if WD 1410 is a smart phone, the interaction may be via a touch screen; if WD 1410 is a smart meter, the interaction may be through a screen that provides usage (e.g., the number of gallons used) or a speaker that provides an audible alert (e.g., if smoke is detected). User interface equipment 1432 may include input interfaces, devices and circuits, and output interfaces, devices and circuits. User interface equipment 1432 is configured to allow input of information into WD 1410, and is connected to processing circuitry 1420 to allow processing circuitry 1420 to process the input information. User interface equipment 1432 may include, for example, a microphone, a proximity or other sensor, keys/buttons, a touch display, one or more cameras, a USB port, or other input circuitry. User interface equipment 1432 is also configured to allow output of information from WD 1410, and to allow processing circuitry 1420 to output information from WD 1410. User interface equipment 1432 may include, for example, a speaker, a display, vibrating circuitry, a USB port, a headphone interface, or other output circuitry. Using one or more input and output interfaces, devices, and circuits, of user interface equipment 1432, WD 1410 may communicate with end users and/or the wireless network, and allow them to benefit from the functionality described herein.

Auxiliary equipment 1434 is operable to provide more specific functionality which may not be generally performed by WDs. This may comprise specialized sensors for doing measurements for various purposes, interfaces for additional types of communication such as wired communications etc. The inclusion and type of components of auxiliary equipment 1434 may vary depending on the embodiment and/or scenario.

Power source 1436 may, in some embodiments, be in the form of a battery or battery pack. Other types of power sources, such as an external power source (e.g., an electricity outlet), photovoltaic devices or power cells, may also be used. WD 1410 may further comprise power circuitry 1437 for delivering power from power source 1436 to the various parts of WD 1410 which need power from power source 1436 to carry out any functionality described or indicated herein. Power circuitry 1437 may in certain embodiments comprise power management circuitry. Power circuitry 1437 may additionally or alternatively be operable to receive power from an external power source; in which case WD 1410 may be connectable to the external power source (such as an electricity outlet) via input circuitry or an interface such as an electrical power cable. Power circuitry 1437 may also in certain embodiments be operable to deliver power from an external power source to power source 1436. This may be, for example, for the charging of power source 1436. Power circuitry 1437 may perform any formatting, converting, or other modification to the power from power source 1436 to make the power suitable for the respective components of WD 1410 to which power is supplied.

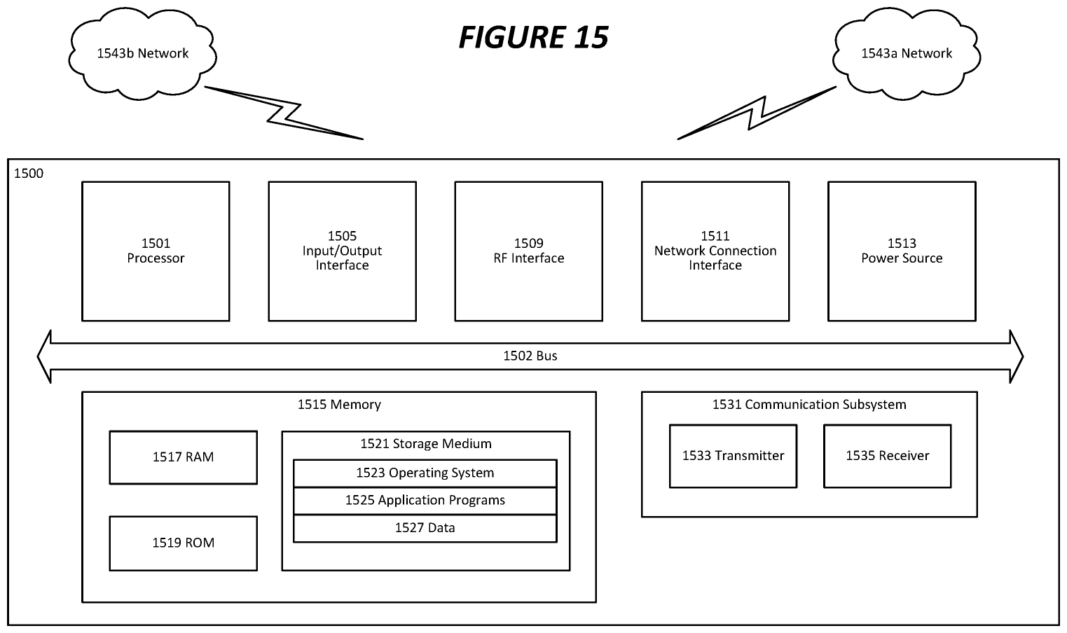

FIG. 15: User Equipment in accordance with some embodiments

FIG. 15 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 15200 may be any UE identified by the 3rd Generation Partnership Project (3GPP), including a NB-1° T UE, a machine type communication (MTC) UE, and/or an enhanced MTC (eMTC) UE. UE 1500, as illustrated in FIG. 15, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 15 is a UE, the components discussed herein are equally applicable to a WD, and vice-versa.

In FIG. 15, UE 1500 includes processing circuitry 1501 that is operatively coupled to input/output interface 1505, radio frequency (RF) interface 1509, network connection interface 1511, memory 1515 including random access memory (RAM) 1517, read-only memory (ROM) 1519, and storage medium 1521 or the like, communication subsystem 1531, power source 1513, and/or any other component, or any combination thereof. Storage medium 1521 includes operating system 1523, application program 1525, and data 1527. In other embodiments, storage medium 1521 may include other similar types of information. Certain UEs may utilize all of the components shown in FIG. 15, or only a subset of the components. The level of integration between the components may vary from one UE to another UE. Further, certain UEs may contain multiple instances of a component, such as multiple processors, memories, transceivers, transmitters, receivers, etc.

In FIG. 15, processing circuitry 1501 may be configured to process computer instructions and data. Processing circuitry 1501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1501 may include two central processing units (CPUs). Data may be information in a form suitable for use by a computer.

In the depicted embodiment, input/output interface 1505 may be configured to provide a communication interface to an input device, output device, or input and output device. UE 1500 may be configured to use an output device via input/output interface 1505. An output device may use the same type of interface port as an input device. For example, a USB port may be used to provide input to and output from UE 1500. The output device may be a speaker, a sound card, a video card, a display, a monitor, a printer, an actuator, an emitter, a smartcard, another output device, or any combination thereof. UE 1500 may be configured to use an input device via input/output interface 1505 to allow a user to capture information into UE 1500. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 15, RF interface 1509 may be configured to provide a communication interface to RF components such as a transmitter, a receiver, and an antenna. Network connection interface 1511 may be configured to provide a communication interface to network 1543a. Network 1543a may encompass wired and/or wireless networks such as a local-area network (LAN), a wide-area network (WAN), a computer network, a wireless network, a telecommunications network, another like network or any combination thereof. For example, network 1543a may comprise a Wi-Fi network. Network connection interface 1511 may be configured to include a receiver and a transmitter interface used to communicate with one or more other devices over a communication network according to one or more communication protocols, such as Ethernet, TCP/IP, SONET, ATM, or the like. Network connection interface 1511 may implement receiver and transmitter functionality appropriate to the communication network links (e.g., optical, electrical, and the like). The transmitter and receiver functions may share circuit components, software or firmware, or alternatively may be implemented separately.

RAM 1517 may be configured to interface via bus 1502 to processing circuitry 1501 to provide storage or caching of data or computer instructions during the execution of software programs such as the operating system, application programs, and device drivers. ROM 1519 may be configured to provide computer instructions or data to processing circuitry 1501. For example, ROM 1519 may be configured to store invariant low-level system code or data for basic system functions such as basic input and output (I/O), startup, or reception of keystrokes from a keyboard that are stored in a non-volatile memory. Storage medium 1521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1521 may be configured to include operating system 1523, application program 1525 such as a web browser application, a widget or gadget engine or another application, and data file 1527. Storage medium 1521 may store, for use by UE 1500, any of a variety of various operating systems or combinations of operating systems.

Storage medium 1521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1521 may allow UE 1500 to access computer-executable instructions, application programs or the like, stored on transitory or non-transitory memory media, to off-load data, or to upload data. An article of manufacture, such as one utilizing a communication system may be tangibly embodied in storage medium 1521, which may comprise a device readable medium.

In FIG. 15, processing circuitry 1501 may be configured to communicate with network 1543b using communication subsystem 1531. Network 1543a and network 1543b may be the same network or networks or different network or networks. Communication subsystem 1531 may be configured to include one or more transceivers used to communicate with network 1543b. For example, communication subsystem 1531 may be configured to include one or more transceivers used to communicate with one or more remote transceivers of another device capable of wireless communication such as another WD, UE, or base station of a radio access network (RAN) according to one or more communication protocols, such as IEEE 802.15, CDMA, WCDMA, GSM, LTE, UTRAN, WiMax, or the like. Each transceiver may include transmitter 1533 and/or receiver 1535 to implement transmitter or receiver functionality, respectively, appropriate to the RAN links (e.g., frequency allocations and the like). Further, transmitter 1533 and receiver 1535 of each transceiver may share circuit components, software or firmware, or alternatively may be implemented separately.

In the illustrated embodiment, the communication functions of communication subsystem 1531 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1531 may include cellular communication, Wi-Fi communication, Bluetooth communication, and GPS communication. Network 1543b may encompass wired and/or wireless networks such as a local-area network (LAN), a wide-area network (WAN), a computer network, a wireless network, a telecommunications network, another like network or any combination thereof. For example, network 1543b may be a cellular network, a Wi-Fi network, and/or a near-field network. Power source 1513 may be configured to provide alternating current (AC) or direct current (DC) power to components of UE 1500.

The features, benefits and/or functions described herein may be implemented in one of the components of UE 1500 or partitioned across multiple components of UE 1500. Further, the features, benefits, and/or functions described herein may be implemented in any combination of hardware, software or firmware. In one example, communication subsystem 1531 may be configured to include any of the components described herein. Further, processing circuitry 1501 may be configured to communicate with any of such components over bus 1502. In another example, any of such components may be represented by program instructions stored in memory that when executed by processing circuitry 1501 perform the corresponding functions described herein. In another example, the functionality of any of such components may be partitioned between processing circuitry 1501 and communication subsystem 1531. In another example, the non-computationally intensive functions of any of such components may be implemented in software or firmware and the computationally intensive functions may be implemented in hardware.

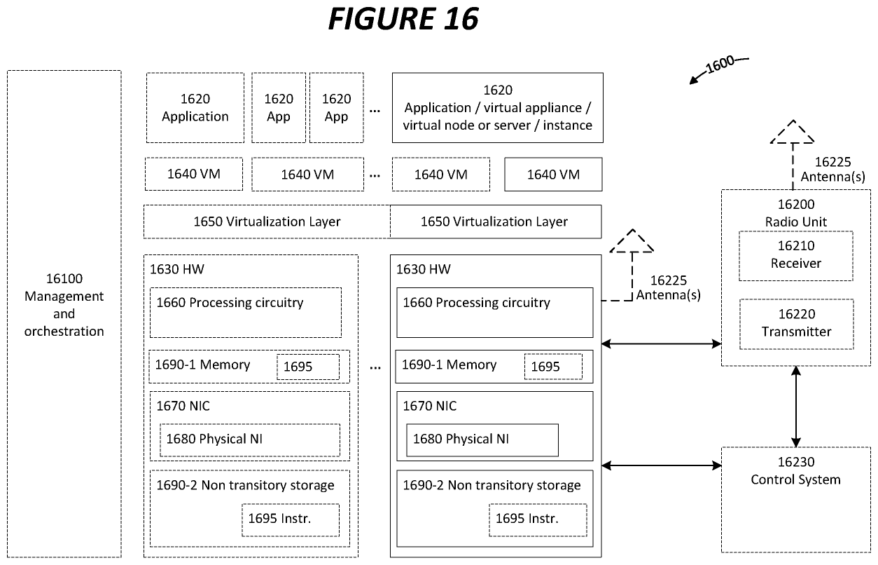

FIG. 16: Virtualization environment in accordance with some embodiments

FIG. 16 is a schematic block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1600 hosted by one or more of hardware nodes 1630. Further, in embodiments in which the virtual node is not a radio access node or does not require radio connectivity (e.g., a core network node), then the network node may be entirely virtualized.

The functions may be implemented by one or more applications 1620 (which may alternatively be called software instances, virtual appliances, network functions, virtual nodes, virtual network functions, etc.) operative to implement some of the features, functions, and/or benefits of some of the embodiments disclosed herein. Applications 1620 are run in virtualization environment 1600 which provides hardware 1630 comprising processing circuitry 1660 and memory 1690. Memory 1690 contains instructions 1695 executable by processing circuitry 1660 whereby application 1620 is operative to provide one or more of the features, benefits, and/or functions disclosed herein.

Virtualization environment 1600, comprises general-purpose or special-purpose network hardware devices 1630 comprising a set of one or more processors or processing circuitry 1660, which may be commercial off-the-shelf (COTS) processors, dedicated Application Specific Integrated Circuits (ASICs), or any other type of processing circuitry including digital or analog hardware components or special purpose processors. Each hardware device may comprise memory 1690-1 which may be non-persistent memory for temporarily storing instructions 1695 or software executed by processing circuitry 1660. Each hardware device may comprise one or more network interface controllers (NICs) 1670, also known as network interface cards, which include physical network interface 1680. Each hardware device may also include non-transitory, persistent, machine-readable storage media 1690-2 having stored therein software 1695 and/or instructions executable by processing circuitry 1660. Software 1695 may include any type of software including software for instantiating one or more virtualization layers 1650 (also referred to as hypervisors), software to execute virtual machines 1640 as well as software allowing it to execute functions, features and/or benefits described in relation with some embodiments described herein.

Virtual machines 1640, comprise virtual processing, virtual memory, virtual networking or interface and virtual storage, and may be run by a corresponding virtualization layer 1650 or hypervisor. Different embodiments of the instance of virtual appliance 1620 may be implemented on one or more of virtual machines 1640, and the implementations may be made in different ways.

During operation, processing circuitry 1660 executes software 1695 to instantiate the hypervisor or virtualization layer 1650, which may sometimes be referred to as a virtual machine monitor (VMM). Virtualization layer 1650 may present a virtual operating platform that appears like networking hardware to virtual machine 1640.

As shown in FIG. 16, hardware 1630 may be a standalone network node with generic or specific components. Hardware 1630 may comprise antenna 16225 and may implement some functions via virtualization. Alternatively, hardware 1630 may be part of a larger cluster of hardware (e.g. such as in a data center or customer premise equipment (CPE)) where many hardware nodes work together and are managed via management and orchestration (MANO) 16100, which, among others, oversees lifecycle management of applications 1620.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1640 may be a software implementation of a physical machine that runs programs as if they were executing on a physical, non-virtualized machine. Each of virtual machines 1640, and that part of hardware 1630 that executes that virtual machine, be it hardware dedicated to that virtual machine and/or hardware shared by that virtual machine with others of the virtual machines 1640, forms a separate virtual network elements (VNE).

Still in the context of NFV, Virtual Network Function (VNF) is responsible for handling specific network functions that run in one or more virtual machines 1640 on top of hardware networking infrastructure 1630 and corresponds to application 1620 in FIG. 16.

In some embodiments, one or more radio units 16200 that each include one or more transmitters 16220 and one or more receivers 16210 may be coupled to one or more antennas 16225. Radio units 16200 may communicate directly with hardware nodes 1630 via one or more appropriate network interfaces and may be used in combination with the virtual components to provide a virtual node with radio capabilities, such as a radio access node or a base station.

In some embodiments, some signalling can be effected with the use of control system 16230 which may alternatively be used for communication between the hardware nodes 1630 and radio units 16200.

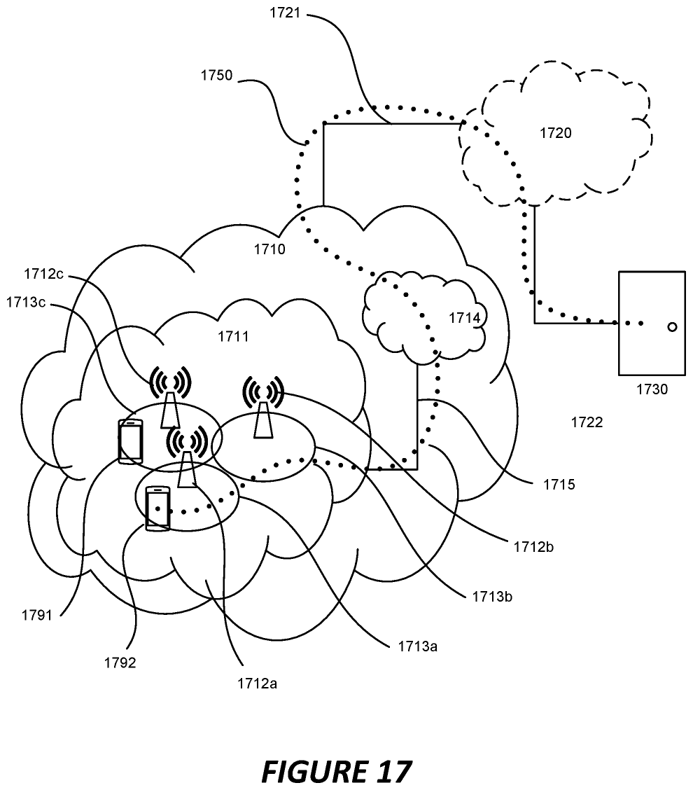

FIG. 17: Telecommunication network connected via an intermediate network to a host computer in accordance with some embodiments.

With reference to FIG. 17, in accordance with an embodiment, a communication system includes telecommunication network 1710, such as a 3GPP-type cellular network, which comprises access network 1711, such as a radio access network, and core network 1714. Access network 1711 comprises a plurality of base stations 1712a, 1712b, 1712c, such as NBs, eNBs, gNBs or other types of wireless access points, each defining a corresponding coverage area 1713a, 1713b, 1713c. Each base station 1712a, 1712b, 1712c is connectable to core network 1714 over a wired or wireless connection 1715. A first UE 1791 located in coverage area 1713c is configured to wirelessly connect to, or be paged by, the corresponding base station 1712c. A second UE 1792 in coverage area 1713a is wirelessly connectable to the corresponding base station 1712a. While a plurality of UEs 1791, 1792 are illustrated in this example, the disclosed embodiments are equally applicable to a situation where a sole UE is in the coverage area or where a sole UE is connecting to the corresponding base station 1712.

Telecommunication network 1710 is itself connected to host computer 1730, which may be embodied in the hardware and/or software of a standalone server, a cloud-implemented server, a distributed server or as processing resources in a server farm. Host computer 1730 may be under the ownership or control of a service provider, or may be operated by the service provider or on behalf of the service provider. Connections 1721 and 1722 between telecommunication network 1710 and host computer 1730 may extend directly from core network 1714 to host computer 1730 or may go via an optional intermediate network 1720. Intermediate network 1720 may be one of, or a combination of more than one of, a public, private or hosted network; intermediate network 1720, if any, may be a backbone network or the Internet; in particular, intermediate network 1720 may comprise two or more sub-networks (not shown).

The communication system of FIG. 17 as a whole enables connectivity between the connected UEs 1791, 1792 and host computer 1730. The connectivity may be described as an over-the-top (OTT) connection 1750. Host computer 1730 and the connected UEs 1791, 1792 are configured to communicate data and/or signaling via OTT connection 1750, using access network 1711, core network 1714, any intermediate network 1720 and possible further infrastructure (not shown) as intermediaries. OTT connection 1750 may be transparent in the sense that the participating communication devices through which OTT connection 1750 passes are unaware of routing of uplink and downlink communications. For example, base station 1712 may not or need not be informed about the past routing of an incoming downlink communication with data originating from host computer 1730 to be forwarded (e.g., handed over) to a connected UE 1791. Similarly, base station 1712 need not be aware of the future routing of an outgoing uplink communication originating from the UE 1791 towards the host computer 1730.

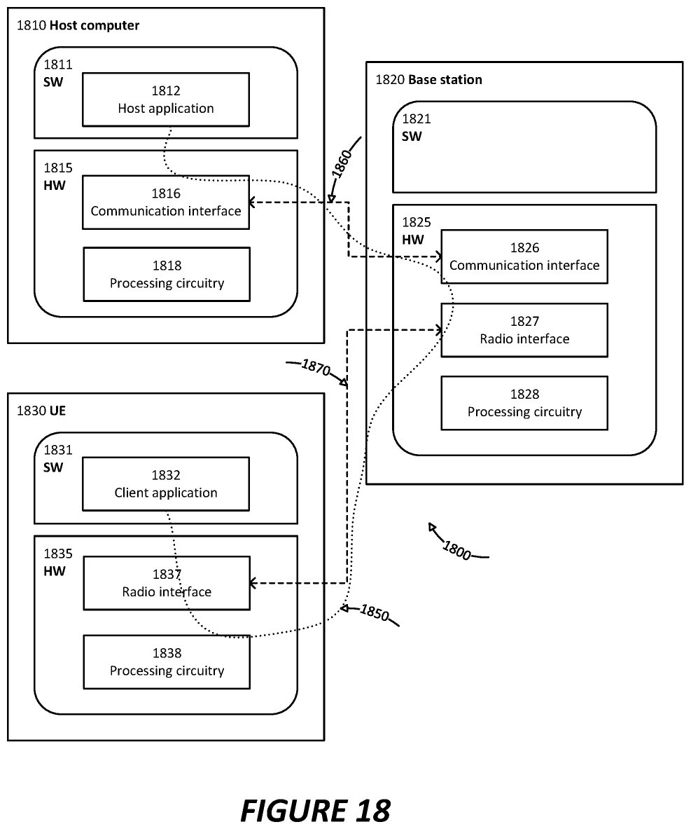

FIG. 18: Host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 18. In communication system 1800, host computer 1810 comprises hardware 1815 including communication interface 1816 configured to set up and maintain a wired or wireless connection with an interface of a different communication device of communication system 1800. Host computer 1810 further comprises processing circuitry 1818, which may have storage and/or processing capabilities. In particular, processing circuitry 1818 may comprise one or more programmable processors, application-specific integrated circuits, field programmable gate arrays or combinations of these (not shown) adapted to execute instructions. Host computer 1810 further comprises software 1811, which is stored in or accessible by host computer 1810 and executable by processing circuitry 1818. Software 1811 includes host application 1812. Host application 1812 may be operable to provide a service to a remote user, such as UE 1830 connecting via OTT connection 1850 terminating at UE 1830 and host computer 1810. In providing the service to the remote user, host application 1812 may provide user data which is transmitted using OTT connection 1850.

Communication system 1800 further includes base station 1820 provided in a telecommunication system and comprising hardware 1825 enabling it to communicate with host computer 1810 and with UE 1830. Hardware 1825 may include communication interface 1826 for setting up and maintaining a wired or wireless connection with an interface of a different communication device of communication system 1800, as well as radio interface 1827 for setting up and maintaining at least wireless connection 1870 with UE 1830 located in a coverage area (not shown in FIG. 18) served by base station 1820. Communication interface 1826 may be configured to facilitate connection 1860 to host computer 1810. Connection 1860 may be direct or it may pass through a core network (not shown in FIG. 18) of the telecommunication system and/or through one or more intermediate networks outside the telecommunication system. In the embodiment shown, hardware 1825 of base station 1820 further includes processing circuitry 1828, which may comprise one or more programmable processors, application-specific integrated circuits, field programmable gate arrays or combinations of these (not shown) adapted to execute instructions. Base station 1820 further has software 1821 stored internally or accessible via an external connection.

Communication system 1800 further includes UE 1830 already referred to. Its hardware 1835 may include radio interface 1837 configured to set up and maintain wireless connection 1870 with a base station serving a coverage area in which UE 1830 is currently located. Hardware 1835 of UE 1830 further includes processing circuitry 1838, which may comprise one or more programmable processors, application-specific integrated circuits, field programmable gate arrays or combinations of these (not shown) adapted to execute instructions. UE 1830 further comprises software 1831, which is stored in or accessible by UE 1830 and executable by processing circuitry 1838. Software 1831 includes client application 1832. Client application 1832 may be operable to provide a service to a human or non-human user via UE 1830, with the support of host computer 1810. In host computer 1810, an executing host application 1812 may communicate with the executing client application 1832 via OTT connection 1850 terminating at UE 1830 and host computer 1810. In providing the service to the user, client application 1832 may receive request data from host application 1812 and provide user data in response to the request data. OTT connection 1850 may transfer both the request data and the user data. Client application 1832 may interact with the user to generate the user data that it provides.

It is noted that host computer 1810, base station 1820 and UE 1830 illustrated in FIG. 18 may be similar or identical to host computer 1730, one of base stations 1712a, 1712b, 1712c and one of UEs 1791, 1792 of FIG. 17, respectively. This is to say, the inner workings of these entities may be as shown in FIG. 18 and independently, the surrounding network topology may be that of FIG. 17.

In FIG. 18, OTT connection 1850 has been drawn abstractly to illustrate the communication between host computer 1810 and UE 1830 via base station 1820, without explicit reference to any intermediary devices and the precise routing of messages via these devices. Network infrastructure may determine the routing, which it may be configured to hide from UE 1830 or from the service provider operating host computer 1810, or both. While OTT connection 1850 is active, the network infrastructure may further take decisions by which it dynamically changes the routing (e.g., on the basis of load balancing consideration or reconfiguration of the network).

Wireless connection 1870 between UE 1830 and base station 1820 is in accordance with the teachings of the embodiments described throughout this disclosure. One or more of the various embodiments may improve the performance of OTT services provided to UE 1830 using OTT connection 1850, in which wireless connection 1870 forms the last segment. More precisely, the teachings of these embodiments may improve the deblock filtering for video processing and thereby provide benefits such as improved video encoding and/or decoding.

A measurement procedure may be provided for the purpose of monitoring data rate, latency and other factors on which the one or more embodiments improve. There may further be an optional network functionality for reconfiguring OTT connection 1850 between host computer 1810 and UE 1830, in response to variations in the measurement results. The measurement procedure and/or the network functionality for reconfiguring OTT connection 1850 may be implemented in software 1811 and hardware 1815 of host computer 1810 or in software 1831 and hardware 1835 of UE 1830, or both. In embodiments, sensors (not shown) may be deployed in or in association with communication devices through which OTT connection 1850 passes; the sensors may participate in the measurement procedure by supplying values of the monitored quantities exemplified above, or supplying values of other physical quantities from which software 1811, 1831 may compute or estimate the monitored quantities. The reconfiguring of OTT connection 1850 may include message format, retransmission settings, preferred routing etc.; the reconfiguring need not affect base station 1820, and it may be unknown or imperceptible to base station 1820. Such procedures and functionalities may be known and practiced in the art. In certain embodiments, measurements may involve proprietary UE signaling facilitating host computer 1810's measurements of throughput, propagation times, latency and the like. The measurements may be implemented in that software 1811 and 1831 causes messages to be transmitted, in particular empty or ‘dummy’ messages, using OTT connection 1850 while it monitors propagation times, errors etc.

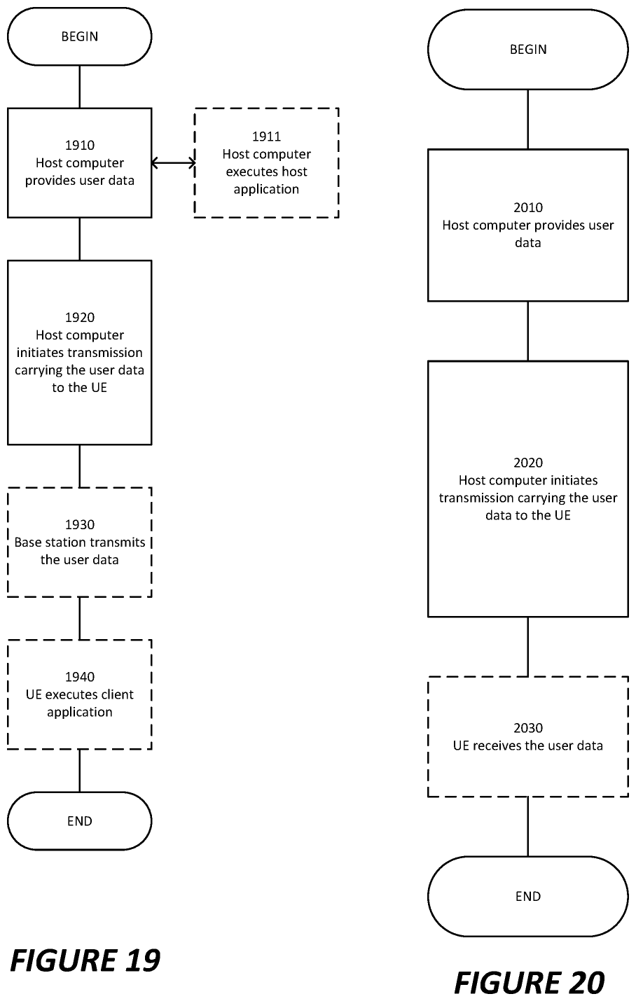

FIG. 19: Methods implemented in a communication system including a host computer, a base station and a user equipment in accordance with some embodiments.

FIG. 19 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 19 will be included in this section. In step 1910, the host computer provides user data. In substep 1911 (which may be optional) of step 1910, the host computer provides the user data by executing a host application. In step 1920, the host computer initiates a transmission carrying the user data to the UE. In step 1930 (which may be optional), the base station transmits to the UE the user data which was carried in the transmission that the host computer initiated, in accordance with the teachings of the embodiments described throughout this disclosure. In step 1940 (which may also be optional), the UE executes a client application associated with the host application executed by the host computer.

FIG. 20: Methods implemented in a communication system including a host computer, a base station and a user equipment in accordance with some embodiments.

FIG. 20 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 20 will be included in this section. In step 2010 of the method, the host computer provides user data. In an optional substep (not shown) the host computer provides the user data by executing a host application. In step 2020, the host computer initiates a transmission carrying the user data to the UE. The transmission may pass via the base station, in accordance with the teachings of the embodiments described throughout this disclosure. In step 2030 (which may be optional), the UE receives the user data carried in the transmission.

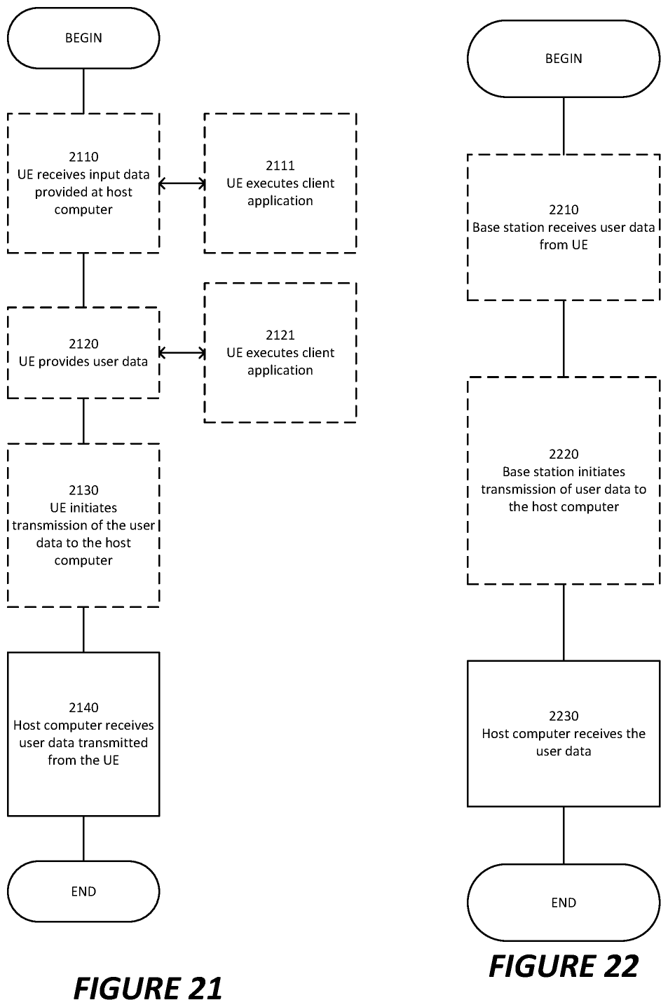

FIG. 21: Methods implemented in a communication system including a host computer, a base station and a user equipment in accordance with some embodiments.

FIG. 21 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 21 will be included in this section. In step 2110 (which may be optional), the UE receives input data provided by the host computer. Additionally or alternatively, in step 2120, the UE provides user data. In substep 2121 (which may be optional) of step 2120, the UE provides the user data by executing a client application. In substep 2111 (which may be optional) of step 2110, the UE executes a client application which provides the user data in reaction to the received input data provided by the host computer. In providing the user data, the executed client application may further consider user input received from the user. Regardless of the specific manner in which the user data was provided, the UE initiates, in substep 2130 (which may be optional), transmission of the user data to the host computer. In step 2140 of the method, the host computer receives the user data transmitted from the UE, in accordance with the teachings of the embodiments described throughout this disclosure.

FIG. 22: Methods implemented in a communication system including a host computer, a base station and a user equipment in accordance with some embodiments.

FIG. 22 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 22 will be included in this section. In step 2210 (which may be optional), in accordance with the teachings of the embodiments described throughout this disclosure, the base station receives user data from the UE. In step 2220 (which may be optional), the base station initiates transmission of the received user data to the host computer. In step 2230 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method performed by a first core network node of a core network of a wireless communication system for authenticating a user equipment, UE, to the core network, the method comprising:
receiving, from a second core network node, a first authentication request to authenticate the UE to the core network, the first authentication request identifying the UE;
determining that the UE should be authenticated by an external authentication entity that is external to the wireless communication system;
transmitting a second authentication request toward the external authentication entity, the second authentication request identifying the UE;
receiving a first authentication response verifying authenticity of the UE;
obtaining a key for securing communications with the UE based on the authentication response; and
transmitting a second authentication response to the second core network node, the second authentication response identifying the UE and including the key for securing communications with the UE.

2. The method of claim 1, wherein determining that the UE should be authenticated by the external authentication entity comprises:
transmitting an authentication get request to a third core network node in response to receiving the first authentication request; and
receiving an authentication get response from the third core network node comprising an authentication profile for the UE, wherein the authentication profile for the UE indicates that the UE should be authenticated by the external authentication entity.

3. The method of claim 2, wherein the core network comprises a 5GC core network, and wherein the third core network node implements a Unified Data Management, UDM, function.

4. The method of claim 1, wherein the core network comprises a 5GC core network, wherein the first core network node implements an Authentication Server Function, AUSF, and wherein the second core network node implements an Access and Mobility Management Function, AMF.

5. The method of claim 1, wherein the wireless communication system comprises a standalone non-public network.

6. The method of claim 1, wherein the first authentication request includes a subscriber concealed identity, SUCI, of the UE, the method further comprising:
determining a subscriber permanent identity, SUPI, of the UE, wherein determining that the UE should be authenticated by the external authentication entity is performed based on the SUCI or the SUPI of the UE, wherein the second authentication request includes the SUPI of the UE.

7. The method of claim 1, wherein the first authentication request comprises a serving network name, SNN, associated with the UE, and wherein the second authentication request includes the SNN.

8. The method of claim 1, wherein:
the first core network node implements an Authentication Server Function, AUSF; and
the key for securing communications with the UE comprises a security anchor function, SEAF, security key, KSEAF.

9.-13. (canceled)

14. A method performed by a core network node of a core network of a wireless communication system for authenticating a user equipment, UE, to the core network, the method comprising:
receiving a registration request from the UE;
transmitting, towards an external authentication entity that is external to the core network, an authentication request to authenticate the UE to the core network, the first authentication request identifying the UE;
receiving an authentication response verifying authenticity of the UE and including a key for securing communications with the UE; and
performing a Security Mode Command, SMC, procedure with the UE using the key for securing communications with the UE.

15. The method of claim 14, wherein the key for securing communications with the UE comprises a security anchor function, SEAF, security key, KSEAF.

16. The method of claim 14, wherein the external authentication entity implements an external Authentication Server Function, AUSF, that is outside the core network.

17. The method of claim 14, wherein the network node implements a Unified Data Management, UDM, function.

18. A method performed by a first core network node of a core network of a wireless communication system for authenticating a user equipment, UE, to the core network, the method comprising:
receiving, from a second core network node, a first authentication request to authenticate the UE to the core network, the first authentication request identifying the UE;
determining that the UE should be authenticated by an external authentication entity that is external to the wireless communication system; and
transmitting a second authentication request toward the external authentication entity, the second authentication request identifying the UE;
wherein determining that the UE should be authenticated by the external authentication entity comprises:
transmitting an authentication request to a third core network node in response to receiving the first authentication request; and
receiving an authentication response from the third core network node, wherein the authentication get response indicates that the UE should be authenticated by the external authentication entity.

19. The method of claim 18, wherein the authentication request comprises an authentication get request, the third core network node implements a unified data management, UDM, function of the core network, and the authentication response comprises an authentication get response.

20. The method of claim 18, wherein the core network comprises a 5GC core network, wherein the first core network node implements an Authentication Server Function, AUSF, and wherein the second core network node implements an Access and Mobility Management Function, AMF.

21. The method of claim 18, wherein the first authentication request includes a subscriber concealed identity, SUCI, of the UE, the method further comprising:
determining a subscriber permanent identity, SUPI, of the UE, wherein determining that the UE should be authenticated by the external authentication entity is performed based on the SUCI or the SUPI of the UE, wherein the second authentication request includes the SUPI of the UE.

22. The method of any of claim 18, wherein the first authentication request comprises a serving network name, SNN, associated with the UE, and wherein the second authentication request includes the SNN.

23. A method performed by a third core network node of a core network of a wireless communication system for authenticating a user equipment, UE, to the core network, the method comprising:
receiving an authentication request from a first core network node; and
transmitting an authentication response to the first core network node, wherein the authentication response indicates that the UE should be authenticated by the external authentication entity.

24. The method of claim 23, wherein the third core network node implements a unified data management, UDM, function of the core network, the first core network implements an Authentication Server Function, AUSF, of the core network, the authentication request comprises an authentication get request, and the authentication response comprises an authentication get response.

25.-26. (canceled)
